(19) United States
(12) Patent Application Publication
(10) Pub. No.: US 2004/0230413 A1
(43) Pub. Date: Nov. 18, 2004

(54) Roller cone bit design using multi-objective optimization

(76) Inventor: Shilin Chen, Woodlands, TX (US)

Correspondence Address: ROBERT GROOVER III, Groover & Holmes, Box 802889, DALLAS, TX, 75380-2889, US

(21) Appl. No.: 10/772,153

(22) Filed: Feb. 4, 2004

Related U.S. Application Data
(63) Continuation-in-part of application No. 09/833,016, filed on Apr. 10, 2001.
Application No. 09/833,016 is a continuation of application No. 09/387,737, filed on Aug. 31, 1999, now Pat. No. 6,213,225.
(63) Continuation-in-part of application No. 10/189,305, filed on Jul. 2, 2002.
Application No. 10/189,305 is a continuation of application No. 09/629,344, filed on Aug. 1, 2000, now Pat. No. 6,412,577.
Application No. 09/629,344 is a continuation of application No. 09/387,304, filed on Aug. 31, 1999, now Pat. No. 6,095,262.
(60) Provisional application No. 60/098,466, filed on Aug. 31, 1998.
(60) Provisional application No. 60/098,442, filed on Aug. 31, 1998.
(60) Provisional application No. 60/474,671, filed on May 30, 2003.
(60) Provisional application No. 60/474,672, filed on May 30, 2003.

(51) Int. Cl. G06G 7/48

(52) U.S. Cl. 703/10

(57) ABSTRACT

The present application describes techniques for optimization of drill bit designs using multiple objectives. Multi-objective optimization permits various factors to be taken into account in a balanced way, without having to decide which factor is most important, or which factors will be dependent on each other.

### CROSS-REFERENCE TO RELATED APPLICATIONS

This application claims priority from U.S. Nonprovisional application Ser. No. 09/833,016 filed Apr. 10, 2001, and therethrough from U.S. Nonprovisional application Ser. No. 09/387,737 filed Aug. 31, 1999 and now issued as U.S. Pat. No. 6,213,225, and therethrough from provisional 60/098,466 filed Aug. 31, 1998.

This application also claims priority from provisional 60/474,671 filed May 30, 2003.

This application also claims priority from provisional 60/474,672 filed May 30, 2003.

This application also claims priority from U.S. Nonprovisional application Ser. No. 10/189,305 filed Jul. 2, 2002, therethrough from U.S. Nonprovisional application Ser. No. 09/629,344 filed Aug. 1, 2000 and now issued as U.S. Pat. No. 6,412,577, and therethrough from U.S. Nonprovisional application Ser. No. 09/387,304 filed Aug. 31, 1999 and now issued as U.S. Pat. No. 6,095,262, and therethrough from provisional 60/098,442 filed Aug. 31, 1998.

### FIELD OF THE INVENTION

The present invention relates generally to the drilling of oil and gas wells, or similar drilling operations, and in particular to orientation of tooth angles on a roller cone drill bit.

### BACKGROUND AND SUMMARY OF THE INVENTION

Background: Rotary Drilling

Oil wells and gas wells are drilled by a process of rotary drilling, using a drill rig such as is shown in FIG. 10. In conventional vertical drilling, a drill bit 10 is mounted on the end of a drill string 12 (drill pipe plus drill collars), which may be more than a mile long, while at the surface a rotary drive (not shown) turns the drill string, including the bit at the bottom of the hole.

Two main types of drill bits are in use. One being the roller cone bit; an example of which is seen in FIG. 11. In this bit, a set of cones 16 (two are visible) having teeth or cutting inserts 18 are arranged on rugged bearings on the arms of the bit. As the drill string is rotated, the cones will roll on the bottom of the hole, and the teeth or cutting inserts will crush the formation beneath them. (The broken fragments of rock are swept uphole by the flow of drilling fluid.) The second type of drill bit is a drag bit, having no moving parts, seen in FIG. 12.

Drag bits are becoming increasingly popular for drilling soft and medium formations, but roller cone bits are still very popular, especially for drilling medium and medium-hard rock. There are various types of roller cone bits: insert-type bits, which are normally used for drilling harder formations, will have teeth of tungsten carbide or some other hard material mounted on their cones. As the drill string rotates and the cones roll along the bottom of the hole, the individual hard teeth will induce compressive failure in the formation.

The bit's teeth must crush or cut rock, with the necessary forces supplied by the “weight on bit” (WOB) which presses the bit down into the rock, and by the torque applied at the rotary drive. While the WOB may in some cases be 100,000 pounds or more, the forces actually seen at the drill bit are not constant: the rock being cut may have harder and softer portions (and may break unevenly), and the drill string itself can oscillate in many different modes. Thus, the drill bit must be able to operate for long periods under high stresses in a remote environment.

When the bit wears out or breaks during drilling, it must be brought up out of the hole. This requires a process called “tripping”: a heavy hoist pulls the entire drill string out of the hole, in stages of (for example) about ninety feet at a time. After each stage of lifting, one “stand” of pipe is unscrewed and laid aside for reassembly (while the weight of the drill string is temporarily supported by another mechanism). Since the total weight of the drill string may be hundreds of tons and the length of the drill string may be tens of thousands of feet, this is not a trivial job. One trip can require tens of hours and is a significant expense in the drilling budget. To resume drilling, the entire process must be reversed. Thus, the bit's durability is very important to minimize round trips for bit replacement during drilling.

Background: Drill String Oscillation

The individual elements of a drill string appear heavy and rigid. However, in the complete drill string (which can be more than a mile long), the individual elements are quite flexible enough to allow oscillation at frequencies near the rotary speed. In fact, many different modes of oscillation are possible. (A simple demonstration of modes of oscillation can be done by twirling a piece of rope or chain: the rope can be twirled in a flat slow circle, or, at faster speeds, so that it appears to cross itself one or more times.) The drill string is actually a much more complex system than a hanging rope and can oscillate in many different ways; see WAVE PROPAGATION IN PETROLEUM ENGINEERING, Wilson C. Chin, (1994).

The oscillations are damped somewhat by the drilling mud, or by friction where the drill pipe rubs against the walls, or by the energy absorbed in fracturing the formation: but often these sources of damping are not enough to prevent oscillation. Since these oscillations occur down in the wellbore, they can be hard to detect but are generally undesirable. Drill string oscillations change the instantaneous force on the bit, and that means that the bit will not operate as designed. For example, the bit may drill oversize, or off-center, or may wear out much sooner than expected. Oscillations are hard to predict since different mechanical forces can combine to produce “coupled modes”; the problems of gyration and whirl are an example of this.

Background: Roller Cone Bit Design

The “cones” in a roller cone bit need not be perfectly conical (nor perfectly frustroconical), but often have a slightly swollen axial profile. Moreover, the axes of the cones do not have to intersect the centerline of the borehole. (The angular difference is referred to as the “offset” angle.) Another variable is the angle by which the centerline of the bearings intersects the horizontal plane of the bottom of the hole, and this angle is known as the journal angle. Thus, as the drill bit is rotated, the cones typically do not roll true, and a certain amount of gouging and scraping takes place. The gouging and scraping action is complex in nature, and varies in magnitude and direction depending on a number of variables.

Conventional roller cone bits can be divided into two broad categories: Insert bits and steel-tooth bits. Steel tooth bits are utilized most frequently in softer formation drilling, whereas insert bits are utilized most frequently in medium and hard formation drilling.

Steel-tooth bits have steel teeth formed integral to the cone. (A hardmetal is typically applied to the surface of the teeth to improve the wear resistance of the structure.) Insert bits have very hard inserts (e.g., specially selected grades of tungsten carbide) pressed into holes drilled into the cone surfaces. The inserts extend outwardly beyond the surface of the cones to form the “teeth” that comprise the cutting structures of the drill bit.

The design of the component elements in a rock bit are interrelated (together with the size limitations imposed by the overall diameter of the bit), and some of the design parameters are driven by the intended use of the product. For example, cone angle and offset can be modified to increase or decrease the amount of bottom hole scraping. Many other design parameters are limited in that an increase in one parameter may necessarily result in a decrease of another. For example, increases in tooth length may cause interference with the adjacent cones.

Background: Tooth Design

The teeth of steel tooth bits are predominantly of the inverted “V” shape. The included angle (i.e., the sharpness of the tip) and the length of the tooth will vary with the design of the bit. In bits designed for harder formations, the teeth will be shorter and the included angle will be greater. Heel row teeth (i.e., the teeth in the outermost row of the cone, next to the outer diameter of the borehole) may have a “T” shaped crest for additional wear resistance.

The most common shapes of inserts are spherical, conical, and chisel. Spherical inserts have a very small protrusion and are used for drilling the hardest formations. Conical inserts have a greater protrusion and a natural resistance to breakage, and are often used for drilling medium hard formations.

Chisel shaped inserts have opposing flats and a broad elongated crest, resembling the teeth of a steel tooth bit. Chisel shaped inserts are used for drilling soft to medium formations. The elongated crest of the chisel insert is normally oriented in alignment with the axis of cone rotation. Thus, unlike spherical and conical inserts, the chisel insert may be directionally oriented about its center axis. (This is true of any tooth which is not axially symmetric.) The axial angle of orientation is measured from the plane intersecting the center of the cone and the center of the tooth.

Background: Rock Mechanics and Formations

There are many factors that determine the drillability of a formation. These include, for example, compressive strength, hardness and/or abrasivity, elasticity, mineral content (stickiness), permeability, porosity, fluid content and interstitial pressure, and state of underground stress.

Soft formations were originally drilled with “fish-tail” drag bits, which sheared the formation away. Roller cone bits designed for drilling soft formations are designed to maximize the gouging and scraping action. To accomplish this, cones are offset to induce the largest allowable deviation from rolling on their true centers. Journal angles are small and cone-profile angles will have relatively large variations. Teeth are long, sharp, and widely-spaced to allow for the greatest possible penetration. Drilling in soft formations is characterized by low weight and high rotary speeds.

Hard formations are drilled by applying high weights on the drill bits and crushing the formation in compressive failure. The rock will fail when the applied load exceeds the strength of the rock. Roller cone bits designed for drilling hard formations are designed to roll as close as possible to a true roll, with little gouging or scraping action. Offset will be zero and journal angles will be higher. Teeth are short and closely spaced to prevent breakage under the high loads. Drilling in hard formations is characterized by high weight and low rotary speeds.

Medium formations are drilled by combining the features of soft and hard formation bits. The rock breaks away (is failed) by combining compressive forces with limited shearing and gouging action that is achieved by designing drill bits with a moderate amount of offset. Tooth length is designed for medium extensions as well. Drilling in medium formations is most often done with weights and rotary speeds between that of the hard and soft formations. Area drilling practices are evaluated to determine the optimum combinations.

Background: Roller Cone Bit Interaction with the Formation

In addition to improving drilling efficiency, the study of bottom hole patterns has allowed engineers to prevent detrimental phenomena such as those known as tracking, and gyration. The impressions a tooth makes into the formation depend largely on the design of the tooth, the tangential and radial scraping motions of the tooth, the force and speed with which the tooth impacts the formation, and the characteristics of the formation. Tracking occurs when the teeth of a drill bit fall into the impressions in the formation formed by other teeth at a preceding moment in time during the revolution of the drill bit. Gyration occurs when a drill bit fails to drill on-center. Both phenomena result in slow rates of penetration, detrimental wear of the cutting structures and premature failure of bits. Other detrimental conditions include excessive uncut rings in the bottom hole pattern. This condition can cause gyration, result in slow rates of penetration, detrimental wear of the cutting structures and premature failure of the bits. Another detrimental phenomenon is bit lateral vibration, which can be caused by radial force imbalances, bit mass imbalance, and bit/formation interaction among other things. This condition includes directional reversals and gyration about the hole center often known as whirl. Lateral vibration results in poor bit performance, overgage hole drilling, out-of-round, or “lobed” wellbores, and premature failure of both the cutting structures and bearing systems of bits. (Kenner and Isbell, DYNAMIC ANALYSIS REVEALS STABILITY OF ROLLER CONE ROCK BITS, SPE 28314, 1994).

Background: Bit Design

Currently, roller cone bit designs remain the result of generations of modifications made to original designs. The modifications are based on years of experience in evaluating bit records, dull bit conditions, and bottom hole patterns.

One method commonly used to discourage bit tracking is known as a staggered tooth design. In this design, the teeth are located at unequal intervals along the circumference of the cone. This is intended to interrupt the recurrent pattern of impressions on the bottom of the hole. Examples of this are shown in U.S. Pat. No. 4,187,922 and UK application 2,241,266.

Background: Shortcomings of Existing Bit Designs

The economics of drilling a well are strongly reliant on rate of penetration. Since the design of the cutting structure of a drill bit controls the bit's ability to achieve a high rate of penetration, cutting structure design plays a significant role in the overall economics of drilling a well. Current bit designs have not solved the issue of tracking. Complex mathematical models can simulate bottom hole patterns to a limited extent, but they do not suggest a solution to the ever-present problem of tracking. The known angular orientations of teeth designed to improve tooth impact strength leave excessive uncut bottom hole patterns and do not solve the problem of tracking. The known angular orientations of teeth designed to increase bottom hole coverage, fail to optimize tooth orientation and do not solve the problem of tracking. Staggered tooth designs do not prevent tracking of the outermost rows of teeth. On the outermost rows of each cone, the teeth are encountering impressions in the formation left by teeth on other cones. The staggered teeth are just as likely to track an impression as any other tooth. Another disadvantage to staggered designs is that they may cause fluctuations in cone rotational speed, resulting in fluctuations in tooth impact force and increased bit vibration. Bit vibration is very harmful to the life of the bit and the life of the entire drill string.

Background: Cutting Structure Design

In the publication A NEW WAY TO CHARACTERIZE THE GOUGING-SCRAPING ACTION OF ROLLER CONE BITS (Ma, Society of Petroleum Engineers No. 19448, 1989), the author determines that a tooth in the first (heel) row of the drill bit evaluated contacts the formation at −22 degrees (measured with respect to rotation of the cone about its journal) and begins to separate at an angle of −6 degrees. The author determines that the contacting range for the second row of the same cone is from −26 degrees to 6 degrees. The author states that “because the crest of the chisel inserts are always in the parallel direction with the generatrix of the roller cone . . . radial scraping will affect the sweep area only slightly.” The author concludes that scraping distance is a more important than the velocity of the cutter in determining performance.

In U.S. Pat. No. 5,197,555, Estes discloses a roller cone bit having opposite angular axial orientation of chisel shaped inserts in the first and second rows of a cone. This invention is premised on the determination that inserts scrape diagonally inboard and either to the leading side (facing in the direction of rotation) or to the trailing side (facing opposite to the direction of rotation). It is noted that the heel row inserts engage the formation to the leading side, while the second row inserts engage the formation to the trailing edge. In one embodiment, the inserts in the heel row are axially oriented at an angle between 30 degrees and 60 degrees, while the inserts in the second row are axially oriented between 300 degrees and 330 degrees. This orientation is designed to provide the inserts with a higher resistance to breakage. In an alternative embodiment, the inserts in the heel row are oriented at an axial angle between 300 degrees and 330 degrees, while the inserts in the second row are axially oriented between 30 degrees and 60 degrees. This orientation is designed to provide the inserts with a broader contact area with the formation for increased formation removal, and thereby an increased rate of penetration of the drill bit into the formation.

Background: Single Objective Optimization

A single objective optimization problem can be stated as

Minimize f(x)

Gᵢ(x)=0, i=1, . . . m

Subject to: Gⱼ(x)≦0, j=1, . . . n (1)

xₗ≦x≦xᵤ

Where x is the vector of design parameters, f(x) is the objective function, G(x) is a vector function representing the equality and inequality constraints. Both objective function and constraint function may be linear or nonlinear functions.

Roller Cone Bit Design Using Multi-Objective Optimization

Design of roller cone drill bits is a complicated procedure, and optimization is very difficult. Before the late 1990s, optimization was normally a one-at-a-time activity of skilled designers. Since the 1999 publications of the present inventor, computer software has begun to be actually used in the design process in a new way, helping the designer refine and optimize specific designs for specific drilling conditions and formation properties.

The ultimate goals of drill bit design are rate of penetration and durability or bit life, but many intermediate targets can be used to help achieve these ultimate goals. For example, it is desirable that the average bit-axial force component be approximately equal on the three arms of the bit (“force balance”), and/or that the average volumetric rate of material removal be equal for the three cones of the bit (“energy balance”). For another example, it is generally desirable to minimize the bit net lateral force due to the tooth interactions with the hole bottom (“lateral balance”).

The question is how to address these intermediate objectives. The present application describes techniques for optimization of drill bit designs using multiple objectives. Multi-objective optimization permits various factors to be taken into account in a balanced way, without having to decide which factor is most important, or which factors will be dependent on each other.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is a flow chart of the optimization procedure disclosed in the present invention.

FIG. 2 shows the tangential and radial velocity components of tooth trajectory, viewed through the cutting face (i.e., looking up).

FIGS. 3A, 3B, 3C, and 3D show plots of planar tooth trajectories for teeth in four rows of a single cone, referenced to the XY coordinates of FIG. 2.

FIGS. 4A and 4B show tangential and radial scraping distances, respectively, for the four tooth trajectories shown in FIGS. 3A-3D.

FIG. 5 is a sectional view of a cone (normal to its axis), showing how the tooth orientation is defined.

FIG. 6 shows time-domain plots of tooth tangential speed, for the five rows of a sample cone, over the duration of the trajectory for each row.

FIGS. 7A and 7B show how optimization of tooth orientation can perturb the width of uncut rings on the hole bottom.

FIGS. 8A and 8B show how optimization of tooth orientation can disturb the tooth clearances.

FIGS. 9A, 9B and 9C show the screen views which a skilled bit designer would see, according to some embodiments of the invention, while working on a bit optimization which included optimization of tooth orientation.

FIG. 10 shows a drill rig in which bits optimized by the teachings of the present application can be advantageously employed.

FIG. 11 shows a conventional roller cone bit, and FIG. 12 shows a conventional drag bit.

FIG. 13 shows a sample XYZ plot of a non-axisymmetric tooth tip.

FIG. 14 shows axial and sectional views of the i-th cone, and illustrates the enumeration of rows and teeth.

FIGS. 15A-15D show how the planarized tooth trajectories vary as the offset is increased.

FIGS. 16A-16D show how the ERSD and ETSD values vary for all rows of a given cone as offset is increased.

FIG. 17 depicts the three major components of forces on a cone: axial bearing force, weight on cone, and cone moment.

FIG. 18a is an illustration of a conventional unbalanced milled steel tooth bit 1810. FIG. 18b lists the rock volume, weight on cone, bearing force, and bearing moment for each of the three cones of the unbalanced bit 1810.

FIG. 19a shows the optimization of a nonlinear constraint requiring the minimal distance between teeth surfaces be 0.041317 inch. FIG. 19b shows the optimization of another nonlinear constraint controlling the size of uncut bridges between teeth row. FIG. 19c depicts a curved trajectory used to determine the lower and upper bounds of tooth orientation angles.

FIGS. 20a-c show the optimization of the tooth crest length and tooth locations on cones 1-3, respectively, before and after optimization.

FIGS. 21a is an illustration of the now energy-balanced milled steel tooth bit 1810. FIGS. 21b lists the rock volume, weight on cone, bearing force, and bearing moment for each of the three cones of the balanced bit 1810.

FIGS. 22a illustrates the definition of a negative and positive tooth orientation angle. FIGS. 22b lists the orientation angles used for all three cones in energy-balanced bit 1810.

FIGS. 23A-23C shows a sample embodiment of a bit design process, using the teachings of the present application.

### DETAILED DESCRIPTION OF THE PREFERRED EMBODIMENTS

The numerous innovative teachings of the present application will be described with particular reference to the presently preferred embodiment (by way of example, and not of limitation).

Overview of Sample Design Process

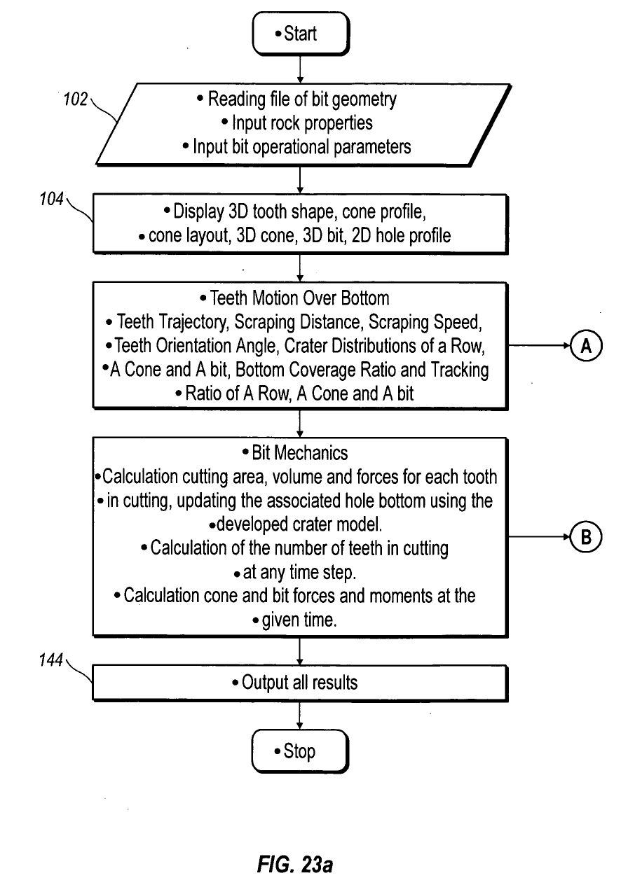

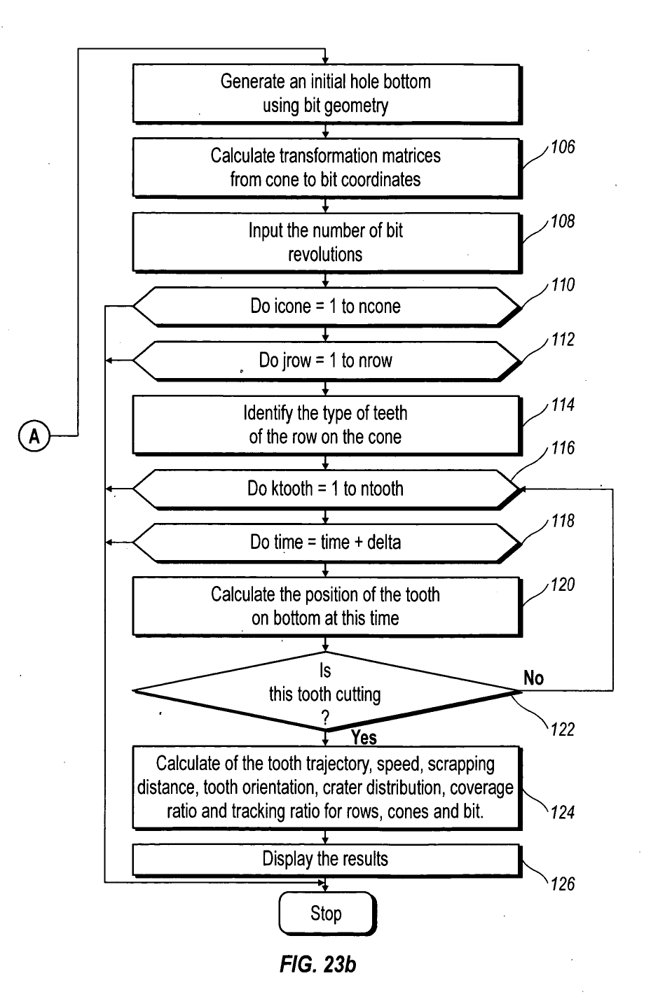

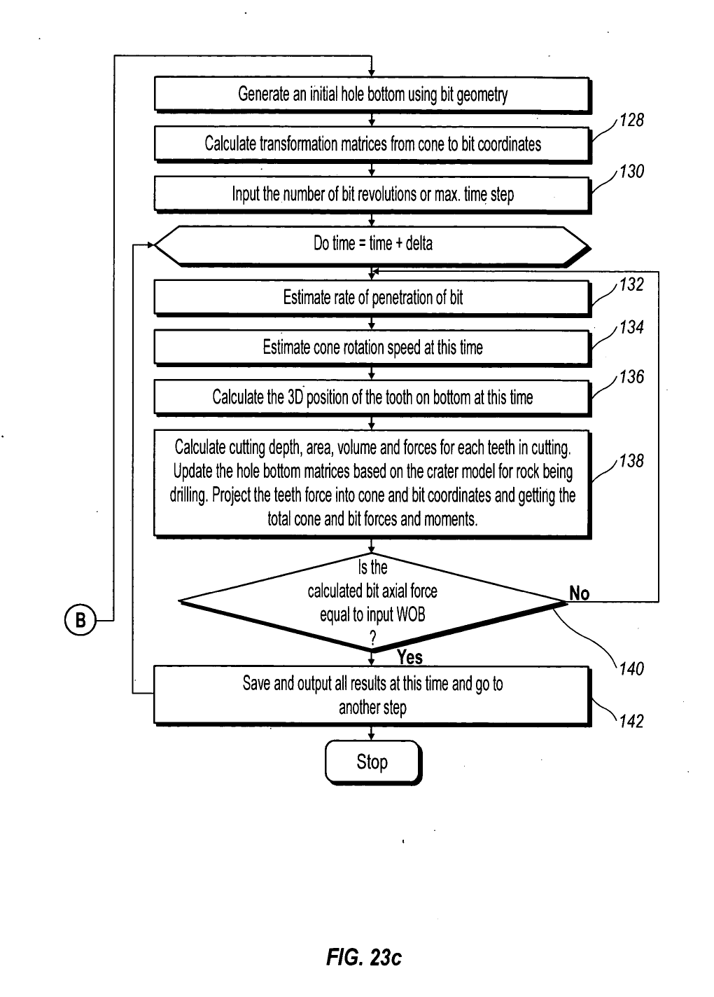

FIGS. 23A-23C show a sample embodiment of a bit design process using the teachings of the present application. Specifically, FIG. 23A shows an overview of the design process, and FIGS. 23B and 23C expand specific parts of the process.

First, the bit geometry, rock properties, and bit operational parameters are input (step 102). The 3D tooth shape, cone profile, cone layout, 3D cone, 3D bit, and 2D hole profile are then displayed (step 104).

Since there are two types of rotation relevant to the calculation of the hole bottom (cone rotation and bit rotation), transformation matrices from cone to bit coordinates must be calculated (step 106). (See FIG. 23B.) The number of bit revolutions is input (step 108), and each cone is counted (step 110), followed by each row of teeth for each cone (step 112). Next, the type of teeth of each row is identified (step 114), and the teeth are counted (step 116). Next, a time interval delta is set (step 118), and the position of each tooth is calculated at this time interval (step 120). If a given tooth is not “cutting” (i.e., in contact with the hole bottom), then the algorithm continues counting until a cutting tooth is reached (step 122). The tooth trajectory, speed, scraping distance, crater distribution, coverage ratio, and tracking ratios for all rows, cones, and the bit are calculated (step 124). This section of the process (depicted in FIG. 23B) gives the teeth motion over the hole bottom and displays the results (step 126).

Next, the bit mechanics are calculated. (See FIG. 23C.) Again, transformation matrices from cone to bit coordinates are calculated (step 128), and the number of bit revolutions and maximum time steps, delta, are input (step 130). The cones are then counted (step 132). The bit and cone rotation angles are calculated at the given time step (step 134), and the rows are counted (step 136). Next, the 3D tooth surface matrices for the teeth on a given row are calculated (step 138). The teeth are then counted (step 140), and the 3D position of the tooth on the hole bottom is calculated at the given time interval (step 142). If a tooth is not cutting, counting continues until a cutting tooth is reached (step 144). The cutting depth, area, volume, and forces for each tooth are calculated, and the hole bottom model is updated (based on the crater model for the type of rock being drilled). Next, the number of teeth cutting at any given time step is counted. The tooth force is projected into cone and bit coordinates, yielding the total cone and bit forces and moments. Finally, the specific energy of the bit is calculated (step 146).

Finally, all results are outputted (step 148). The process can then be reiterated if needed.

Four Coordinate Systems

Four coordinate systems are used, in the presently preferred embodiment, to define the crest point of a tooth in three-dimensional space. All the coordinate system obey the “Right Hand Rule”. These coordinate systems—tooth, cone, bit, and hole—are described below.

Local Tooth Coordinates

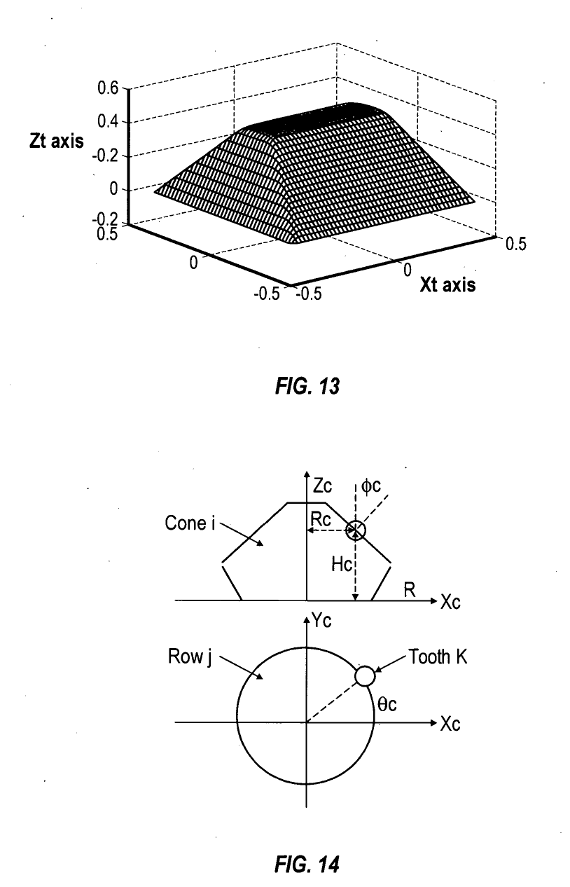

FIG. 13 shows a sample XYZ plot of a tooth tip (in tooth local coordinates). Tooth coordinates will be indicated here by the subscript t. (Of course, each tooth has its own tooth coordinate system.) The center of the XₜYₜZₜ coordinate system, in the presently preferred embodiment, is located at the tooth center. The coordinate of a tooth's crest point Pₜ will be defined by parameters of the tooth profile (e.g., tooth diameter, extension, etc.).

Cone Coordinates

FIG. 14 shows axial and sectional views of the i-th cone, and illustrates the enumeration of rows and teeth. Cone coordinates will be indicated here by the subscript c. The center of the cone coordinates is located in the center of backface of the cone. The cone body is fixed with respect to these coordinates, and hence THESE COORDINATES ROTATE WITH THE CONE. (Of course, each cone has its own cone coordinate system.) The axis Z_{c} coincides with the cone axis, and is oriented towards to the bit center. Cone axes Y_{c} and X_{c}, together with axis Z_{c}, follow the right hand rule. As shown in FIG. 13, four parameters are enough to completely define the coordinate of the crest point of a tooth on cone profile. These four parameters are H_{c}, R_{c}, φ_{c}, and θ_{c}. For all the teeth on the same row, H_{c}, R_{c}, and φ_{c} are the same.

Bit Coordinates

Similarly, a set of bit axes X_{b}Y_{b}Z_{b}, indicated by the subscript b, is aligned to the bit. The bit is fixed with respect to these coordinates, and hence THESE COORDINATES ROTATE WITH THE BIT. Axis Z_{b} preferably points toward the cutting face, and axes X_{b} and Y_{b} are normal to Z_{b} (and follow the right-hand rule).

Hole Coordinates

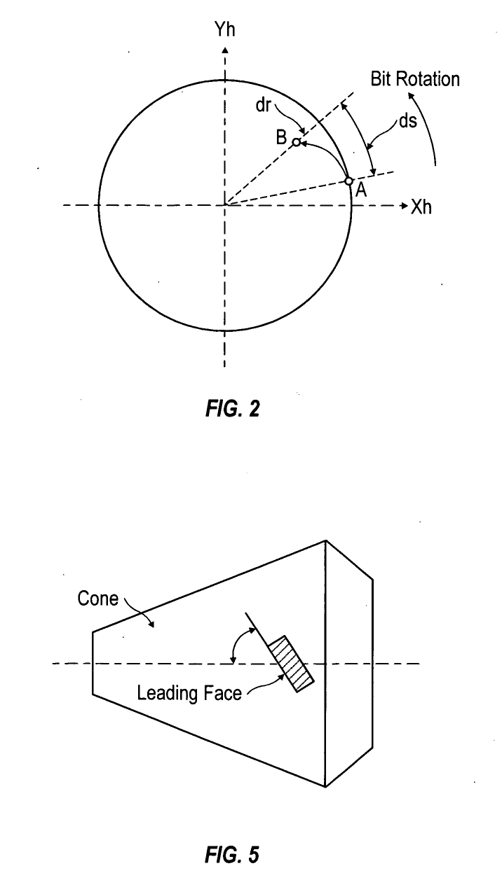

The simplest coordinate system is defined by the hole axes XₕYₕZₕ, which are fixed in space. Note, however, that axes Z_{b} and Zₕ may not be coincident if the bit is tilted. FIG. 2 shows the tangential and radial velocity components of tooth trajectory viewed through the cutting face (i.e., looking up). Illustrated is a small portion of a tooth trajectory, wherein a tooth's crest (projected into an XₕYₕ plane which approximates the bottom of the hole) moves from point A to point B, over an arc distance ds and a radial distance dr.

Transformations

Since all of these coordinate systems are xyz systems, they can be interrelated by simple matrix transformations.

Both the bit and the cones are rotating with time. In order to calculate the position on hole bottom where the crest point of a tooth engages into formation and the position that the crest point of a tooth disengages from formation, all the teeth positions at any time must be described in hole coordinate system XₕYₕZₕ.

The transformation from tooth coordinates XₜYₜZₜ to cone coordinates X_{c}Y_{c}Z_{c} can be defined by a matrix Rtc, which is a matrix function of teeth parameters:

Rtc=ƒ(H_{c}, R_{c}, θ_{c}, φ_{c}),

so that any point Pₜ in XₜYₜZₜ can be transformed into local cone coordinates X_{c}Y_{c}Z_{c} by:

P_{C}=R_{tC}*Pₜ.

At time t=0, it is assumed that the plane X_{c}O_{c}Z_{c} is parallel to the bit axis. At time t, the cone has a rotation angle λ around its negative axis (−Z_{c}). Any point on the cone moves to a new position due to this rotation. The new position of P_{c} in X_{c}Y_{c}Z_{c} can be determined by combining linear transforms.

The transform matrix due to cone rotation is R_{cone}:

R_{cone}=cos(λ)I+(1−cos(λ))NcNc′+sin(λ)Mc,

where N_{c} is the rotation vector and M_{c} is a 3*3 matrix defined by N_{c}.

Therefore, the new position P_{crot} of P_{c} due to cone rotation is:

P_{crot}=R_{cone}*P_{c}

Let R_{cb1}, R_{cb2}, and R_{cb3} be respective transformation matrices (for cones 1, 2, and 3) from cone coordinate to bit coordinates. (These matrices will be functions of bit parameters such as pin angle, offset, and back face length.) Any point P_{ci} in cone coordinates can then be transformed into bit coordinates by:

P_{b}=R_{cbi}*P_{ci}+P_{c0i} for i=1, 2, or 3,

where P_{c0i} is the origin of cone coordinates in the bit coordinate system.

The bit is rotating around its own axis. Let us assume that the bit axes and hole axes are coincident at time t=0. At time t, the bit has a rotation angle β. The transform matrix due to bit rotation is:

Rbh=cos(β)I+(1−cos(β))NbNb′+sin(β)Mb

where Nb is the rotation vector and Mb is a 3*3 matrix defined by Nb. Therefore, any point Pb in bit coordinate system can be transformed into the hole coordinate system XₕYₕZₕ by:

Ph=Rbh *Pb.

Therefore, the position of the crest point of any tooth at any time in three-dimensional space has been fully defined by the foregoing seven equations. In order to further determine the engage and disengage point, the formation is modeled, in the presently preferred embodiment, by multiple stepped horizontal planes. (The number of horizontal planes depends on the total number of rows in the bit.) In this way, the trajectory of any tooth on hole bottom can be determined.

Calculation of Trajectories in Bottomhole Plane

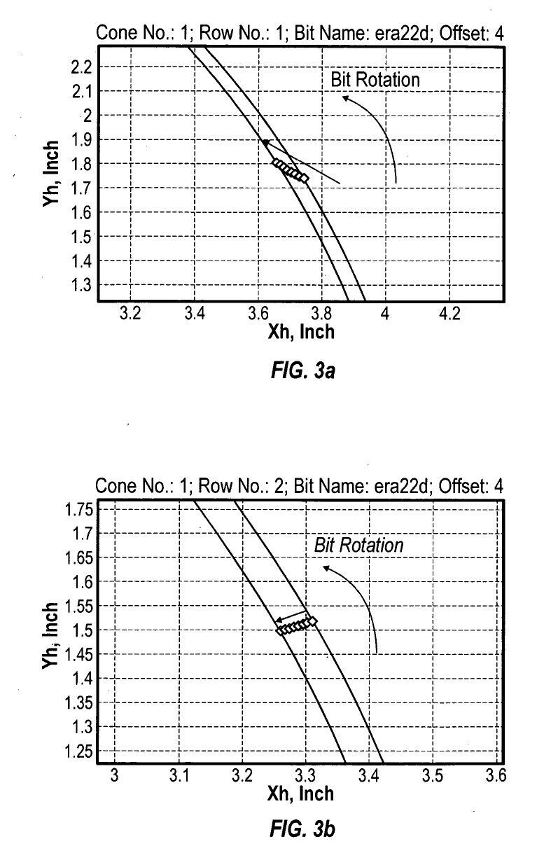

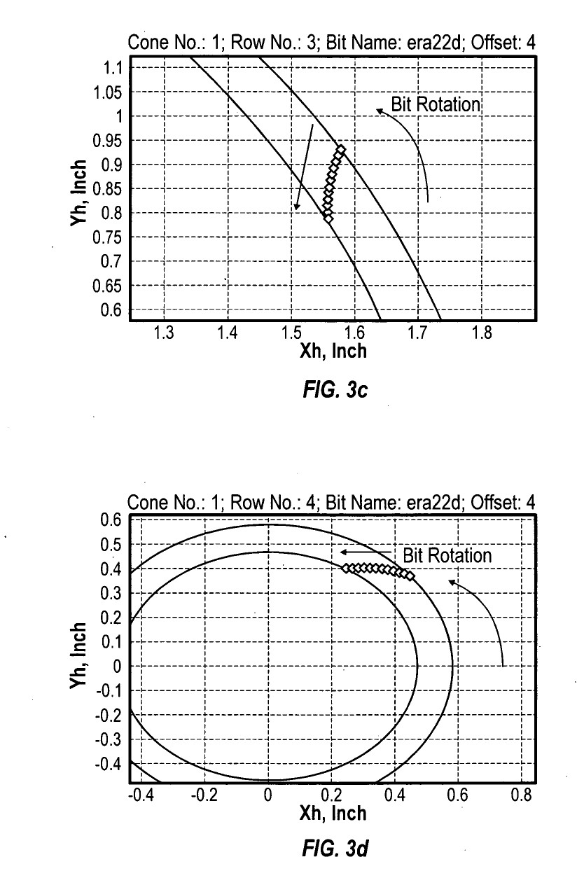

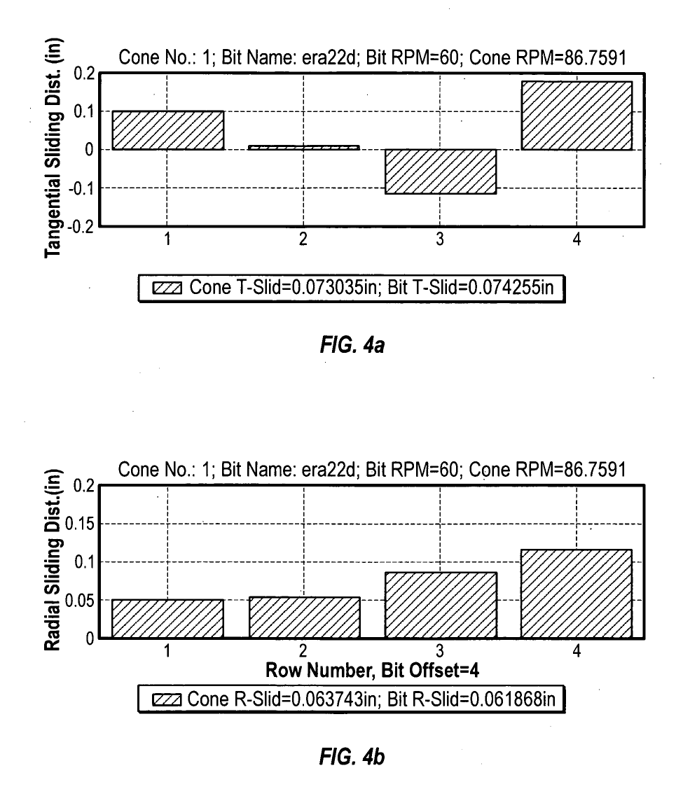

With the foregoing transformations, the trajectory of the tooth crest across the bottom of the hole can be calculated. FIGS. 3A, 3B, 3C, and 3D show plots of planar tooth trajectories, referenced to the hole coordinates XhYh, for teeth on four different rows of a particular roller cone bit. The teeth on the outermost row (first row) scrapes toward the leading side of the cone. Its radial and tangential scraping distances are similar, as can be seen by comparing the first bar in FIG. 4A with the first bar in FIG. 4B. However, for teeth on the second row, the radial scraping motion is much larger than the tangent motion. The teeth on the third row scrape toward the trailing side of the cone, and the teeth on the forth row scrape toward the leading side of the cone.

FIGS. 4A and 4B show per-bit-revolution tangential and radial scraping distances, respectively, for the four tooth trajectories shown in FIGS. 3A-3D. Note that, in this example, the motion of the second row is almost entirely radial and not tangential.

Projection of Trajectories into Cone Coordinates

The tooth trajectories described above are projected on the hole bottom which is fixed in space. In this way, it is clearly seen how the tooth scrapes over the bottom. However, for the bit manufacturer or bit designer, it is necessary to know the teeth orientation angle on the cone coordinate in order either to keep the elongate side of the tooth perpendicular to the scraping direction (for maximum cutting rate in softer formations) or to keep the elongate side of the tooth in line with the scraping direction (for durability in harder formations). To this end, the tooth trajectories are projected to the cone coordinate system. Let P₁={x₁, y₁, z₁}_{c} and P₂={x₂, y₂, z₂}_{c} be the engage and disengage points on cone coordinate system, respectively, and approximate the tooth trajectory P₁-P₂ as a straight line. Then the scraping angle in cone coordinates is:

$${R}_{S} = \sqrt{{( {x}_{2} - {x}_{1} )}^{2} + {( {y}_{1} + {y}_{2} )}^{2}}$$

$$and$$

$${γ}_{s} = {tan}^{- 1} ( \frac{{R}_{S}}{{z}_{2} - {z}_{1}} )$$

The teeth can then be oriented appropriately with respect to this angle gamma. For example, for soft formation drilling the tooth would preferably be oriented so that its broad side is perpendicular to the scraping direction, in order to increase its rate of rock removal. In this case, the direction γ_{c} of the elongate crest of the tooth, in cone coordinates, is normal to γₛ, i.e., γ_{c}=γₛ+π/2. Conversely, for drilling harder formations with a chisel-shaped tooth it might be preferable to orient the tooth with minimum frontal area in the direction of scraping, i.e., with γ_{c}=γₛ.

Derivation of Equivalent Radial and Tangential Scraping

There are numerous parameters in roller cone design, and experienced designers already know, qualitatively, that changes in cone shape (cone angle, heel angle, third angle, and oversize angle) as well as offset and journal angle will affect the scraping pattern of teeth in order to get a desired action-on-bottom. One problem is that it is not easy to describe a desired action-on-bottom quantitatively. The present application provides techniques for addressing this need.

Two new parameters have been defined in order to quantitatively evaluate the cone shape and offset effects on tooth scraping motion. Both of these parameters can be applied either to a bit or to individual cones.

(1) Equivalent Tangent Scraping Distance (ETSD) is equal to the total tangent scraping distance of all teeth on a cone (or bit) divided by the total number of the teeth on the cone (or bit).

(2) Equivalent Radial Scraping Distance (ERSD) is equal to the total radial scraping distance of all teeth on a cone (or bit) divided by the total number of the teeth on the cone (or bit).

Both of these two parameters they have much more clear physical meaning than the offset value and cone shape.

Surprisingly, the arcuate (or bulged) shape of the cone primarily affects the ETSD value, and the offset determines the ERSD value. Also surprisingly, the ERSD is not equal to zero even at zero offset. In other words, the teeth on a bit without offset may still have some small radial scraping effects.

The radial scraping direction for all teeth is always toward to the hole center (positive). However, the tangential scraping direction is usually different from row to row.

In order to use the scraping effects fully and effectively, the leading side of the elongated teeth crest should be orientated at an angle to the plane of the cone's axis, which is calculated as described above for any given row.

FIG. 2 shows the procedure in which a tooth cuts into (point A) and out (point B) the formation. Due to bit offset, arcuate cone shape and bit and cone rotations, the motion from A to B can be divided into two parts: tangent motion ds and radial motion dr. Notice the tangent and radial motions are defined in hole coordinate system XhYh. Because ds and dr vary from row to row and from cone to cone, we derive an equivalent tangent scraping distance (ETSD) and an equivalent radial scraping distance (ERSD) for a whole cone (or for an entire bit).

For a cone, we have

$$ETDS = \frac{{\sum }_{j}^{Nr} {ds}_{j} {Nt}_{j}}{Nc}$$

$$and$$

$$ERSD = \frac{{\sum }_{j}^{Nr} {dr}_{j} {Nt}_{j}}{Nc}$$

where Nc is the total tooth count of a cone and Nr is the number of rows of a cone.

Similarly for a bit, we have

$$ETSD = \frac{{\sum }_{i}^{3} {\sum }_{j}^{Nr} {ds}_{ij} {Nt}_{ij}}{Nb}$$

$$and$$

$$ERSD = \frac{{\sum }_{i}^{3} {\sum }_{j}^{Nr} {dr}_{ij} {Nt}_{ij}}{Nb}$$

where Nb is the total tooth count of the bit.

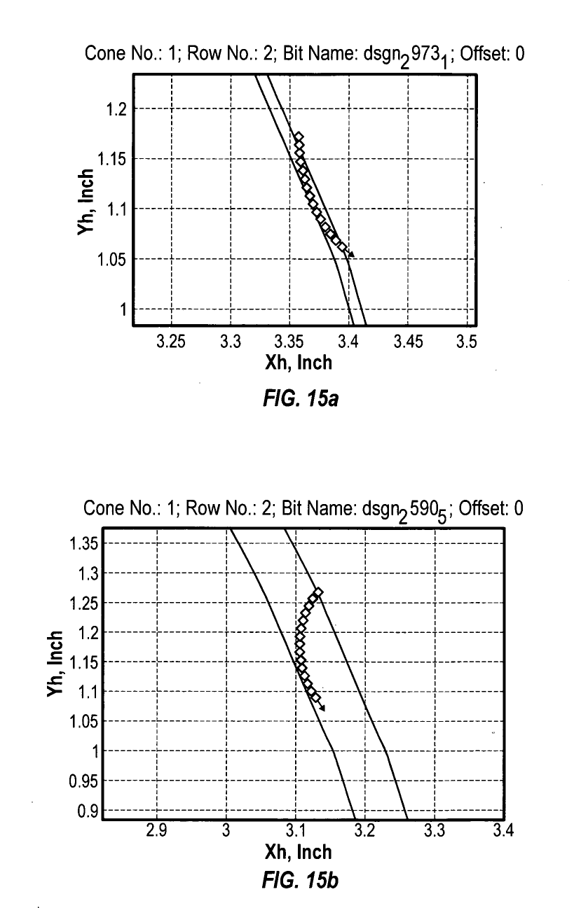

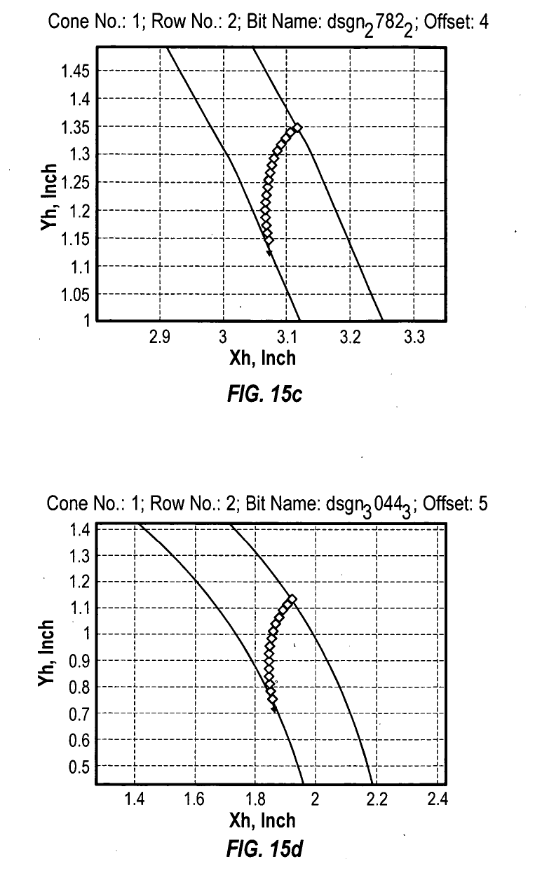

FIGS. 15A-15D show how the planarized tooth trajectories vary as the offset is increased. These figures clearly show that with the increase of the offset value, the radial scraping distance is increased. Surprisingly, the radial scraping distance is not equal to zero even if the offset is zero. This is due to the arcuate shape of the cone.

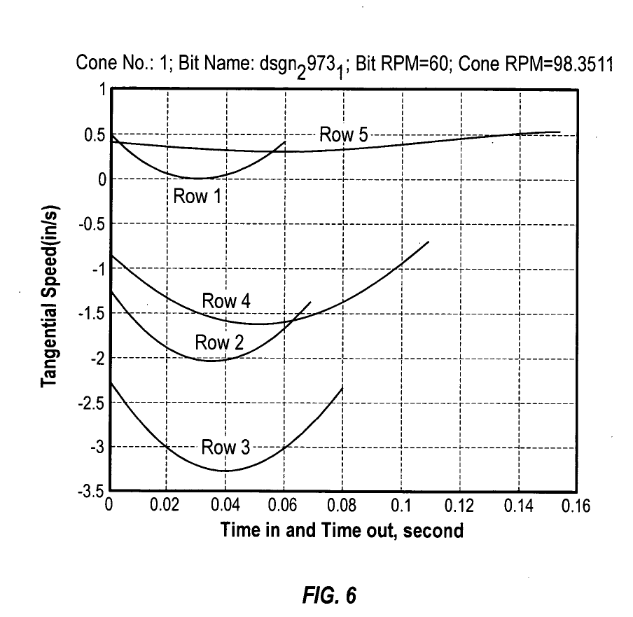

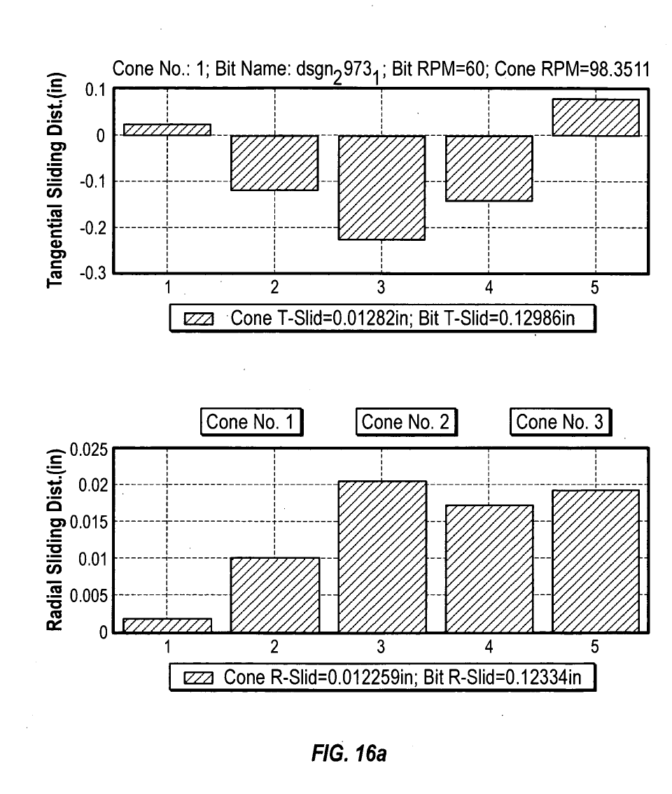

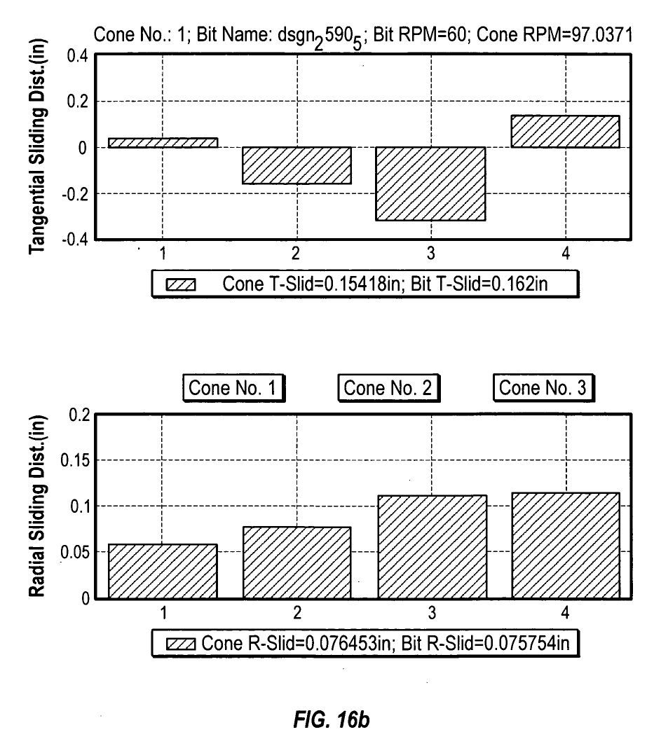

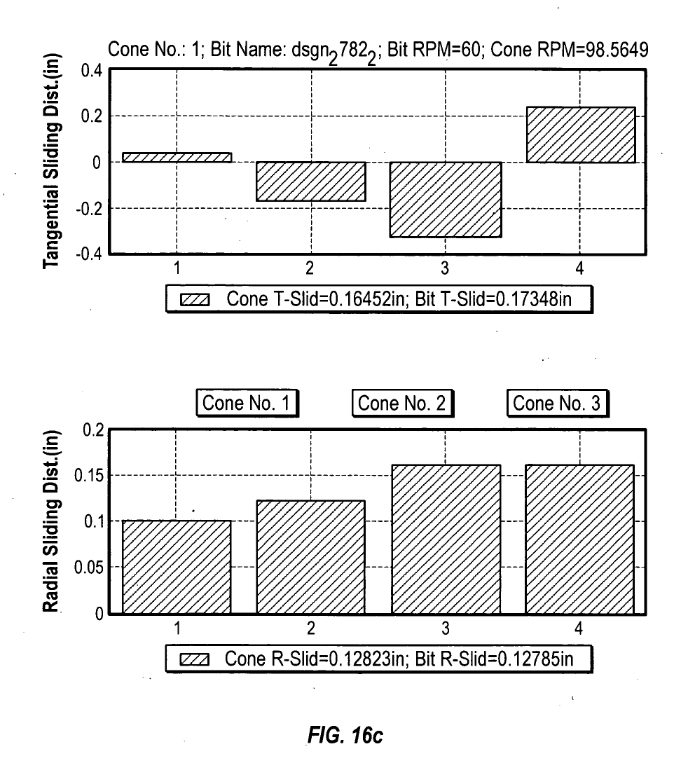

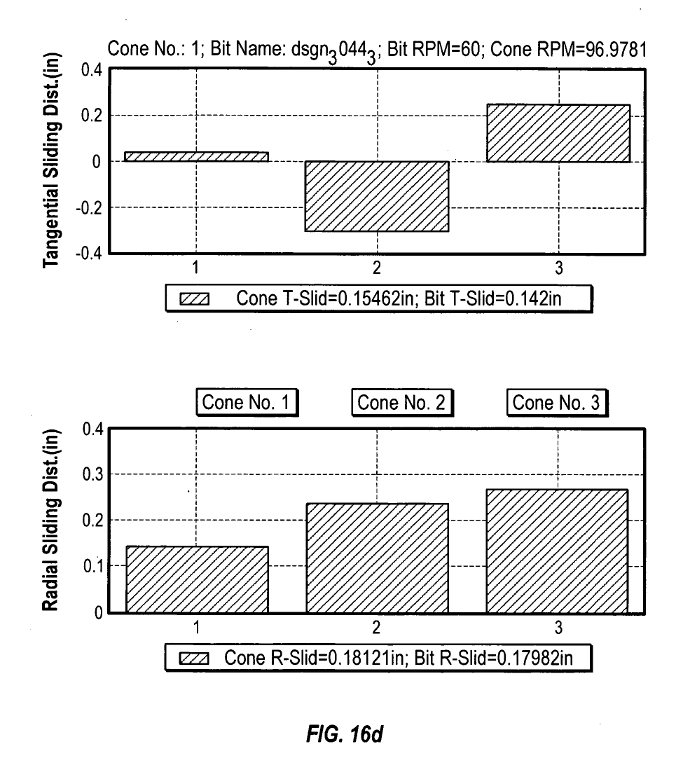

FIGS. 16A-16D show how the ERSD and ETSD values vary for all rows of a given cone as offset is increased. From these Figures, it can be seen that the tangent scraping distance of the gage row, while very small compared to other rows but is not equal to zero. It means that there is a sliding even for the teeth on the driving row. This fact may be explained by looking at the tangent speed during the entry and exit of teeth into and out of the rock. (FIG. 6 shows time-domain plots of tooth tangential speed, for the five rows of a sample cone, over the duration of the trajectory for each row.) During the cutting procedure, the tangent speed is not equal to zero except for one instant. Because the sliding speed changes with time, the instantaneous speed is not the best way to describe the teeth/rock interaction.

Note that the tangent scraping directions are different from row to row for the same cone. FIG. 5 is a sectional view of a cone (normal to its axis), showing how the tooth orientation is defined in the present application: the positive direction is defined as the same direction as the bit rotation. This means that the leading side of tooth on one row may be different from that on another row.

The ERSD increases almost proportionally with the increase of the bit offset. However, ERSD is not zero even if the bit offset is zero. This is because the radial sliding speed is not always zero during the procedure of tooth cutting into and cutting out the rock.

Calculation of Uncut Rings, and Row Position Adjustment

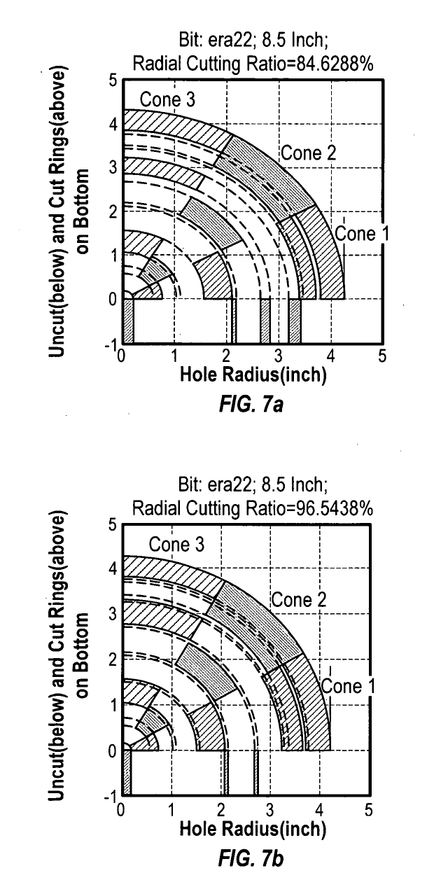

FIGS. 7A and 7B show how optimization of tooth orientation can perturb the width of uncut rings on the hole bottom. The width of uncut rings is one of the design constraints: a sufficiently narrow uncut ring will be easily fractured by adjacent cutter action and mud flows, but too large an uncut ring will slow rate of penetration. Thus, one of the significant teachings of the present application is that tooth orientation should not be adjusted in isolation, but preferably should be optimized jointly with the width of uncut rings.

Interference Check

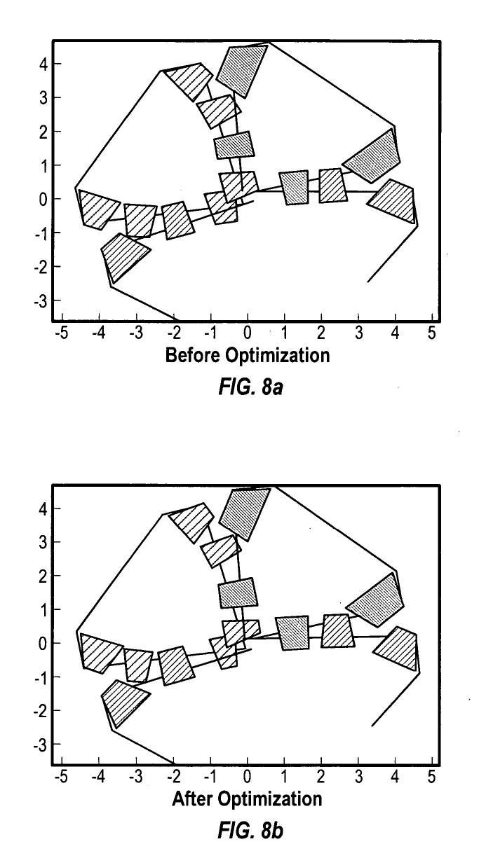

Another constraint is tooth interference. In the crowded geometries of an optimized roller cone design, it is easy for an adjustment to row position to cause interference between cones. FIGS. 8A and 8B graphically show how optimization of tooth orientation can disturb the tooth clearances. Thus, optimization of tooth orientation is preferably followed by an interference check (especially if row positions are changed).

Iteration

Preferably, multiple iterations of the various optimizations are used, to ensure that the various constraints and/or requirements are all jointly satisfied according to an optimal tradeoff.

Graphic Display

The scraping motion of any tooth on any row is visualized on the designer's computer screen. The bit designer has a chance to see quantitatively how large the motion is and in which direction if bit geometric parameters like cone shape and offset are changed.

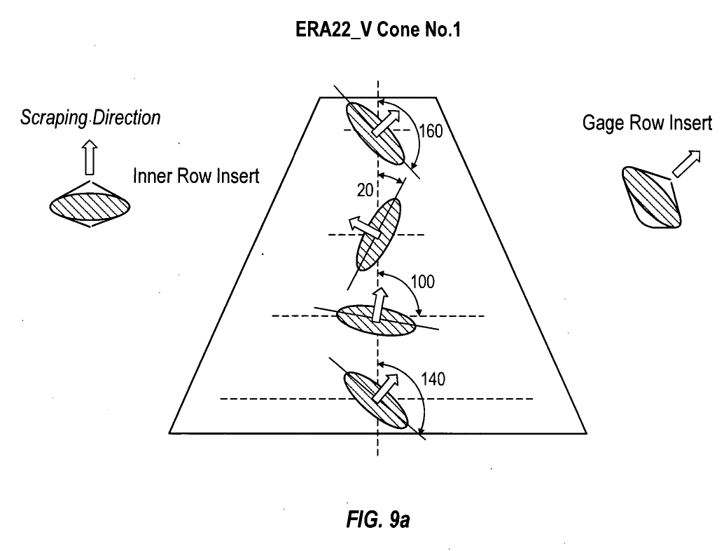

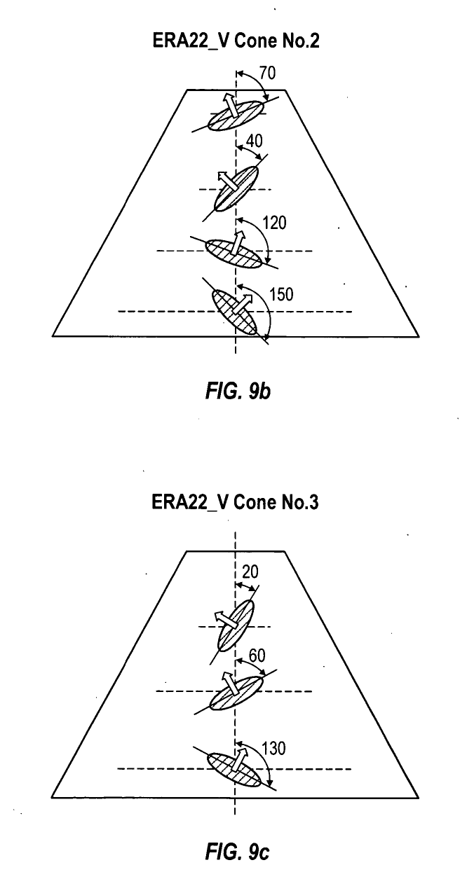

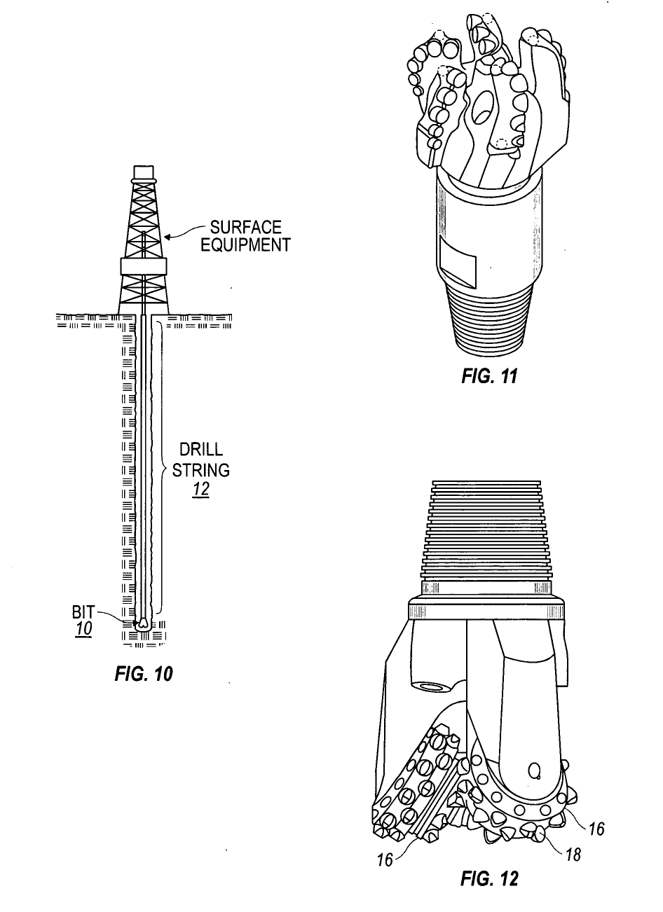

FIGS. 9A, 9B and 9C show the screen views which a skilled bit designer would see, according to some embodiments of the invention, while working on a bit optimization which included optimization of tooth orientation. These three views show representations of tooth orientation and scraping direction for each tooth row on each of the three cones. This simple display allows the designer to get a feel for the effect of various parameter variations

Multi-objective Optimization

Multi-objective optimization is concerned with the minimization of a vector of objectives F(x) that may be the subject of a number of constraints:

Minimize F(x)

Gᵢ(x)=0, i=1, . . . m

Subject to: Gⱼ(x)≦0, j=1, . . . n (2)

xₗ≦x≦xᵤ

Where x is a design variable with lower and upper bounds. F(x) is a vector and represents multiple objectives. G(x) is a vector function representing the equality and inequality constraints. Both objective function and constraint function may be linear or nonlinear functions.

There are many algorithms available to solve this multi-objective optimization problem. Goal Attainment Method developed by Gembicki and its modifications is one of the most efficient methods.

Modifications of an Objective

In multi-objective optimization, objectives may have different physical meanings, and their numerical values may significantly differ from each other. In this case, modifications of objective expression become necessary. For example, if one objective function is volumetric balance, that can be evaluated as the sum of the squares of the differences of each cone's rate from the average rate, i.e.

V₀=(V₁−V_{avg})²+(V₂−V_{avg})²+(V₃−V_{avg})². (3)

This formula (or some analogous formula, as discussed below) provides a single scalar value for each objective function. However, some further manipulation is preferably used to combine them.

Numerical Combination of Objective Values: Ultimately the separate objective values will be combined with some formula such as

Net Value=(A−A₀)²+(B−B₀)²+. . . (4)

or more generally

Net Value=Summa{wⱼ(|Aⱼ−Aⱼ₀)|^{Ej})} (5)

where

Aⱼ is the j-th objective function value,

Eⱼ is the nonlinearity value for that objective function, and

Wⱼ is a weight given to the j-th objective function. (All the wⱼ values add up to 1.)

Normalization: In the above example, the volume imbalance V₀ would ideally be zero. However, for nonzero values of V₀, the size of V₀ will depend somewhat on V_{avg}. Therefore, V₀ can be normalized to make it independent of the magnitude of V_{avg}, e.g.

V*₀=V₀/V_{avg}. (6)

Other objective functions can optionally be normalized in a similar way.

Translation: The above formula for V₀ was set up so that the ideal outcome would be V₀=0. However, if another definition had been used, this would not necessarily be true. For example, if the definition

V′₀=(V₁/(V₂+V₃))²+(V₂/(V₁+V₃))²+(V₃/(V₁+V₂) (7)

is used, then the ideal value of V′₀ would be 0.75. In this case, the definitions can optionally be translated so that the ideal value is zero, e.g.

V′*=0.75−V′₀ (8)

Scaling: Optionally, the objective functions can be scaled into values which all have comparable significance, e.g., where 0 is the ideal value for each objective, the objective values can be scaled so that values below 1 are wholly acceptable (almost perfect), and values above 10 are unacceptable.

Inversion: In some cases, the natural definition of the objective might be to make the largest possible value preferable. (A simple example of this is ROP.) One way to scale this, for comparability with other objectives, is to use a simple inversion, e.g., objective B might be defined as B=1/ROP.

Segmentation: Optionally, the objective function can be constructed using a combination of different relations. For example, if an objective X is scaled so that values of X below 1 are considered to provide no further advantage, then a revised objective value can be defined, for example, as

X″=X² when |X|≧1,

X″=X⁸ when |X|<1. (9)

Note that this particular example retains continuity, which can help to assure that the optimization procedure converges.

Nonlinearity: Optionally, exponents on the different components can be made higher than 2, or made higher than 2 when the objective exceeds a certain preferred maximum value. This provides increased sensitivity to excursions of any one objective if desired.

Application of Multi-objective Optimization in Roller Cone Bit Design

Multiple Objectives

Drilling faster and longer are almost always the major objectives in designing a roller cone bit. In order to meet this objective, innovative design methods have been developed in recent years. One of the innovative methods is the optimization of teeth orientation. Another is the balanced cutting structures of roller cone bit.

In summary, a “perfect” roller cone bit has following objectives:

(1) Maximization of rate of penetration (drilling efficiency)

(2) Maximization of bit life (durability)

The above two objectives may be met by fulfilling some or all of the following sub-objectives:

(a) Maximization of the shear motion by teeth orientation

(b) Maximization of rock volume removed by each tooth

(c) Minimization of the difference of weight on each cone

(d) Minimization of the difference of bearing axial force on each bearing

(e) Minimization of the difference of cone moment on each cone

(f) Minimization of the lateral force of the bit

(g) Minimization of the tracking probability

(h) Minimization of the difference of rock volume removed by each cone

(i) Minimization of the difference of the work done by each cone

(j) Minimization of the difference of the wear on inner cutting structure and outer cutting structure

(k) Minimization of the difference of the insert wear of the bit

(l) Minimization of the difference of the loadings on each insert

(m) Minimization of the shock loadings on tooth, on cone and on bit

(n) . . .

These sub-objectives may be difficult to meet simultaneously and may be traded off in some way. A bit design engineer may usually be able to know the relative importance of these objectives. However, as the number of objectives increases, trade-offs are likely to become complex and less easily quantified. Therefore, it is necessary to develop a computer program to automate the optimization procedure once the objectives are selected or determined.

Multi-objectives of an Energy-Balanced Roller Cone Bit

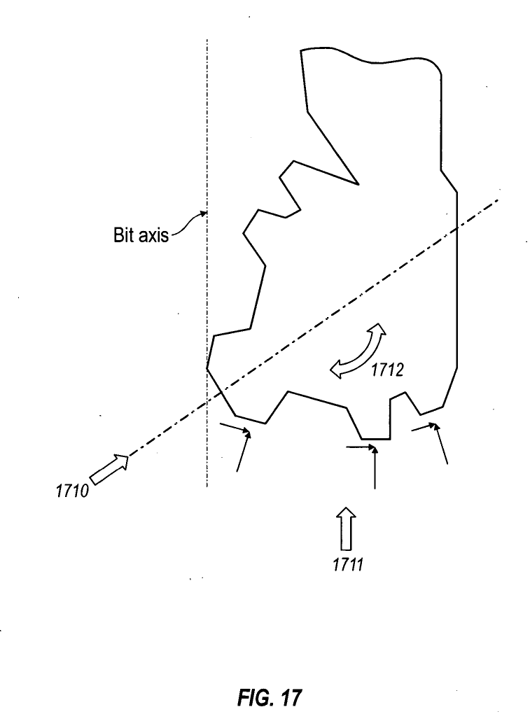

In this section, it will be shown, as an example, how an energy-balanced roller cone bit is designed by using the multi-objective technology. It is required to design a roller cone bit with balanced cutting structure. The balanced cutting structure means that each cone removes the same amount of rock (volume balancing) and each cone subject to the same loads (force balancing). From the cone coordinate system, there are six forces acting on each cone: three linear forces and three moments. From the bit coordinate system, there are still six forces: three linear forces and three moments. However, the bit axial forces on each cone or weight on cone (WOC) are the most important forces because they relate directly to the weight on bit (WOB). It will be difficult to design a roller cone bit in which each cone is subject to the same forces in all directions. The three forces shown in FIG. 17 are considered as the most important forces acting on each cone which directly affect the bit performance: a force 1710 along bearing axial direction, Fb, a force 1711 along bit axial direction (weight on cone), Fw, and a moment 1712 Mc. Therefore, the objectives of an energy-balanced roller cone bit design can be defined as follows:

$$\begin{matrix}\begin{matrix}Objective 1 \text{:} & & \frac{{V}_{max} - {V}_{min}}{{V}_{mean}} \leq {ξ}_{v}\end{matrix} & ( 10 a ) \\ \begin{matrix}Objective 2 \text{:} & & \frac{{Fb}_{max} - {Fb}_{min}}{{Fb}_{mean}} \leq {ξ}_{Fb}\end{matrix} & ( 10 b ) \\ \begin{matrix}Objective 3 \text{:} & & \frac{{Fw}_{max} - {Fw}_{min}}{{Fw}_{mean}} \leq {ξ}_{Fw}\end{matrix} & ( 10 c ) \\ \begin{matrix}Objective 4 \text{:} & & \frac{M {c}_{max} - M {c}_{min}}{M {c}_{mean}} \leq {ξ}_{M c}\end{matrix} & ( 10 d )\end{matrix}$$

Where Vₘₐₓ=max(V₁, V₂, V₃), and Vₘᵢₙ=min(V₁, V₂, V₃), and Vₘₑₐₙ=mean(V₁, V₂, V₃), and V₁, V₂, V₃ are rock removed by each cone, respectively.

Fbₘₐₓ=max(Fb₁, Fb₂, Fb₃), and Fbₘᵢₙ=min(Fb₁, Fb₂, Fb₃), and Fbₘₑₐₙ=mean(Fb₁, Fb₂, Fb₃), and Fb₁, Fb₂, Fb₃ are bearing axial force of each cone, respectively.

FWₘₐₓ=max(Fw₁, Fw₂, Fw₃)x and Fwₘᵢₙ=min(Fw₁, Fw₂, Fw₃), and Fwₘₑₐₙ=mean(Fw₁, Fw₂, Fw₃), and Fw₁, Fw₂,Fw₃ are weight on each cone, respectively.

Mcₘₐₓ=max(Mc₁, Mc₂, Mc₃)x and Mcₘᵢₙ=min(Mc₁, Mc₂, Mc₃), and Mcₘₑₐₙ=mean(Mc₁, Mc₂, Mc₃), and Mc₁, Mc₂, Mc₃ are moment on each cone, respectively.

The balancing criterion defined by ξᵥ,ξ_{Fb},ξ_{Fw},ξ_{Mc}, depend on bit type, bit size. For insert type bit, these numbers should be less than 4%. For steel tooth bit, these numbers should be less than 5%. In most cases, these numbers are less than 2% for any type of roller cone bits.

Objectives as a Function of Design Variables

The above objectives must be expressed mathematically as functions of design variable. However, it is very difficult to express them explicitly because of the complicated three-dimensional bit geometry and the interaction between the teeth and the formation. Instead, a computer subroutine is developed in which design variables are the inputs, and objectives are the output.

As described in U.S. Pat. No. 6,213,225, a tooth is divided into many three-dimensional elements. The force acting on an element is proportional to the rock volume removed by that element. In order to calculate the forces acting on an element, it is necessary to first determine the rock volume removed by this element. To this end, a model to simulate the interaction between teeth and formation is needed. There are two kinds of models that may be used to calculate the volumes and forces.

(1) Volume and Forces Calculated from Three-Dimensional Model

A three-dimensional model of the interaction of the roller cone bit and formation has been developed, and the simulation procedure has been described in U.S. Pat. Nos. 6,095,262 and 6,213,225. Once bit geometric parameters, drilling operational parameters, and formation properties are defined, the three-dimensional model is able to simulate the drilling procedure in time domain. Therefore, the rock removed by any cutting element and the forces acting on any cutting element at any time step can be obtained. However, the run of the model is time costly. For example, a 20-second drilling simulation of an 12¼ steel tooth bit may need five minutes of CPU time. As a result, it is difficult to directly implement the three-dimensional model into the design optimization because optimization itself usually needs several hundreds of iterations. Therefore, it is necessary to first simplify a three-dimensional problem into a two-dimensional one as described below.

(2) Volume and Forces Calculated from Two-Dimensional Model

In this two-dimensional model, the cutting structure of a roller cone bit is projected to a vertical plane passing through the bit axis. The surface of the bottom hole is then formed by rotating the projected profile around the bit axis 360 degrees. Suppose a bit has a cutting depth A in one bit revolution. And for all teeth that are in cutting with the formation, the cutting depth A is assumed to be the same. Therefore, if the rotational speeds of the cone and bit are known, the crater distribution on the bottom will be able to be determined. At this time, it would be simple to calculate the rock volume removed by all the teeth. The volume matrix representing the volume removed by each row may have the form:

V=[Vᵢⱼ],i=1,2,3; j=1,2,3,4 . . . (11)

Where i represents the cone number and j the row number. The elements of this matrix are all the functions of the design variables.

(3) Scaled Volume and Forces Used in the Optimization

In reality, the volume removed by each row depends not only on the above design variable, but also on the tracking condition and the three-dimensional bottom hole condition which vary with time. However, these condition changes are difficult to be sufficiently represented in a two-dimensional model. Therefore, the matrix V from the two-dimensional model must be scaled. The scaled matrix may be obtained from both two-dimensional and three-dimensional models as follows:

Kᵥ(i,j)=V_{3d0}(i,j)/V_{2d0}(i,j) (12)

where V_{3d0}(i,j) is the volume matrix of the initial designed bit under three-dimensional simulation. And V_{2d0}(i,j) is the volume matrix of the initial designed bit under two-dimensional simulation.

The final scaled volume matrix has the following form:

V_{b}(i,j)=Kᵥ(i,j)/V(i,j) (13)

Let V₁, V₂, V₃ be the volume removed by cone 1, cone 2, and cone 3, and this leads to

$${V}_{i} = {\sum }_{i} {\sum }_{j} {V}_{b} ( i , j ) \qquad ( 14 )$$

Where Vᵢ are implicit functions of the design variables. At this point, Objective 1 is defined as:

$$\begin{matrix}Objective 1 \text{:} & & \frac{{V}_{max} - {V}_{min}}{{V}_{mean}} \leq {ξ}_{v}\end{matrix} \qquad ( 10 a )$$

Similarly, the forces acting on each tooth and each cone can be calculated based on matrix V_{b}(i,j). Therefore, the other three objectives related to forces can also be expressed as implicit functions of design variables in the same way and will not be described here.

Design Variables

There are many geometric parameters which can be taken as design variables: bit offset, bearing angle (pin angle), cone profile, row position, number of tooth row, number of teeth, tooth geometry (extension, crest length), tooth orientation angles, etc.

Constraints on Design Variables

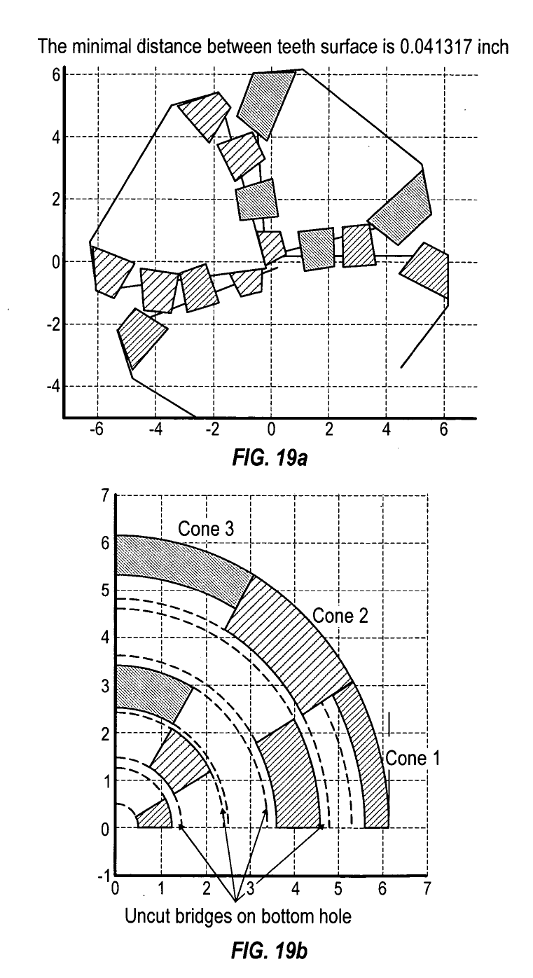

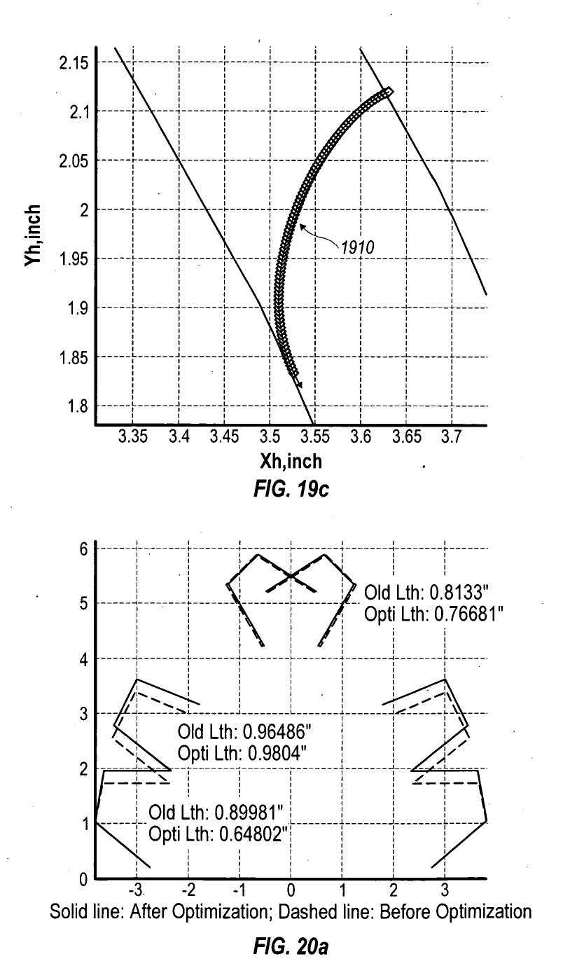

There are two kinds of constraints: linear and nonlinear. The linear constraints are simply the bounds of design variables. For example, the lower and upper bounds of a tooth crest length are determined by requirements on tooth mechanical strength and structural limitation. Another example is the lower and upper bounds of the orientation angle that are calculated from the curved tooth trajectories described in U.S. Pat. No. 6,095,262. FIG. 19c shows an example of a curved trajectory 1910.

The nonlinear constraints represent the relationship among some design variables. A typical nonlinear constraint is the clearance between teeth surfaces on all three cones. FIG. 19a shows the optimization requiring the minimal distance between teeth surfaces to be 0.041317 inch. In order to keep the cone rotate smoothly without teeth interference, a minimum clearance, δ, is required. The clearance can be expressed as a function of the design variables:

g₁(x₁, . . . ,xₙ)≦δ (15)

Another nonlinear constraint is the width of the uncut formation rings (bridges) on bottom. FIG. 19b shows the optimization of this nonlinear constraint. This width should be minimized or equalized to avoid the direct contact of cone surface to formation. This condition can be expressed as:

Δwₘᵢₙ≦g₂(x₁, . . . ,xₙ)≦Δwₘₐₓ (16)

Of course, the explicit expressions of such constraints are difficult to develop. Instead, a computer subroutine is developed where design variables are then input, and clearance is the output.

Software Development

The techniques for solving a multi-objective optimization problem are wide and varied. Among others, the Weighted Sum Method, the Single Objective Method and the Goal Attainment Method are used very often in engineering (Gembicki, 1974, Grace, 1989).

The Goal Attainment Method is applied to solve the multi-objective optimization of the roller cone bit. Using this method, the objectives and the constraints defined above can now be expressed as a standard multi-objective optimization problem using the following formulations:

Minimize γ

f₁(x)−wᵢγ≦gᵢ, i=1,2, . . . m

Gᵢ(x)=0, i=1, . . . m

Subject to: Gⱼ(x)≦0, j=1, . . . n

xₗ≦x≦xᵤ

Where fᵢ(x) is the i-th objective, which is, in this case, one of the 4 objectives, gᵢ, is the associated design goal which is, in this case, the expressions of the right hand side of the objectives. wᵢ is a set of weighting coefficients that determines the search direction, and x is a set of design variables.

During the optimization, γ is varied, which changes the size of the feasible region. The introduction of the term wᵢγ into the problem enables the designer to always find a reasonable optimal solution even when the objectives and constraints are not adequately defined.

Design Procedure

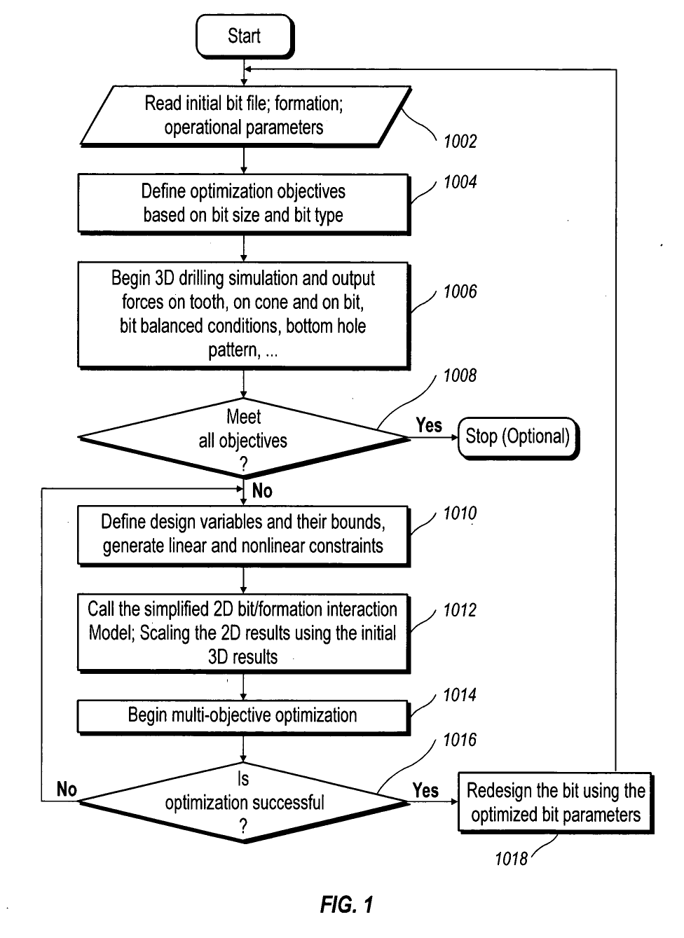

An overview of the design process is shown in FIG. 1. First, the initial bit file, formation, and operational parameters are read (step 1002). The optimization objectives based on bit size and bit type are defined (step 1004). Begin three-dimensional drilling simulation. Output forces on tooth, on cone and on bit, bit-balanced conditions, bottom hole pattern, etc. (step 1006). If all the objectives are not met (step 1008), then the algorithm continues by defining design variables and their bounds and generating linear and nonlinear constraints (step 1010). The algorithm then calls the defined two-dimensional bit/formation interaction model and scales the two-dimensional results using the initial three-dimensional results (step 1012). Multi-objective optimization then begins (step 1014). If the optimization is successful (step 1016), then the bit is redesigned using the optimized bit parameters (step 1018). If not, steps 1010 to 1014 are repeated until optimization is successful.

It should be noted that although the optimization procedure is based on the results of a two-dimensional model, the initial results of the bit from three-dimensional model must be first obtained in order to scale the results of the two-dimensional model. And the final bit design is evaluated using the results from three-dimensional model. In some cases, a bit is optimized in two-dimensional model and may not be optimized in three-dimensional model. If this case occurs, the total optimization procedure must be repeated over again, and the objectives and bounds of design variables have to be changed.

### Design Examples

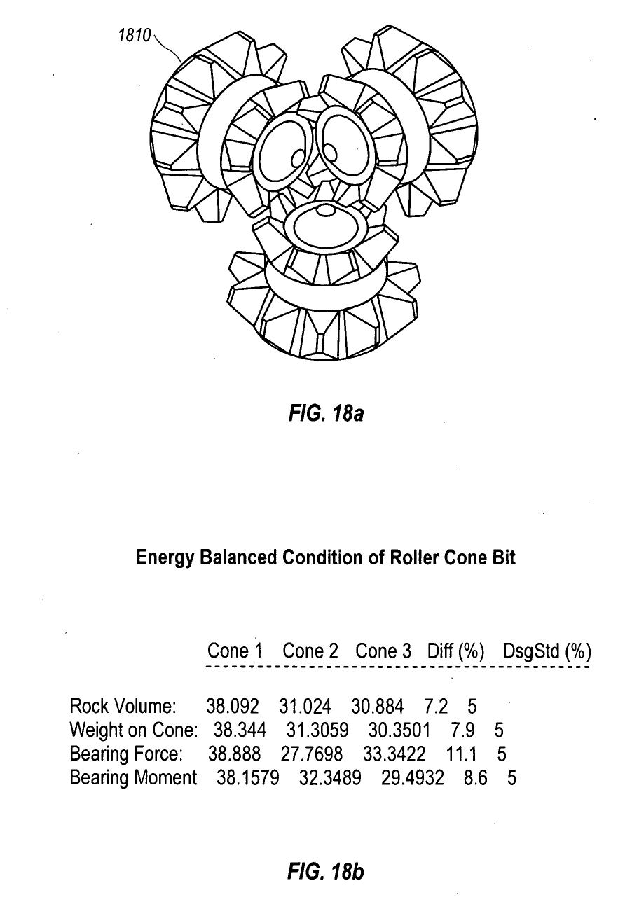

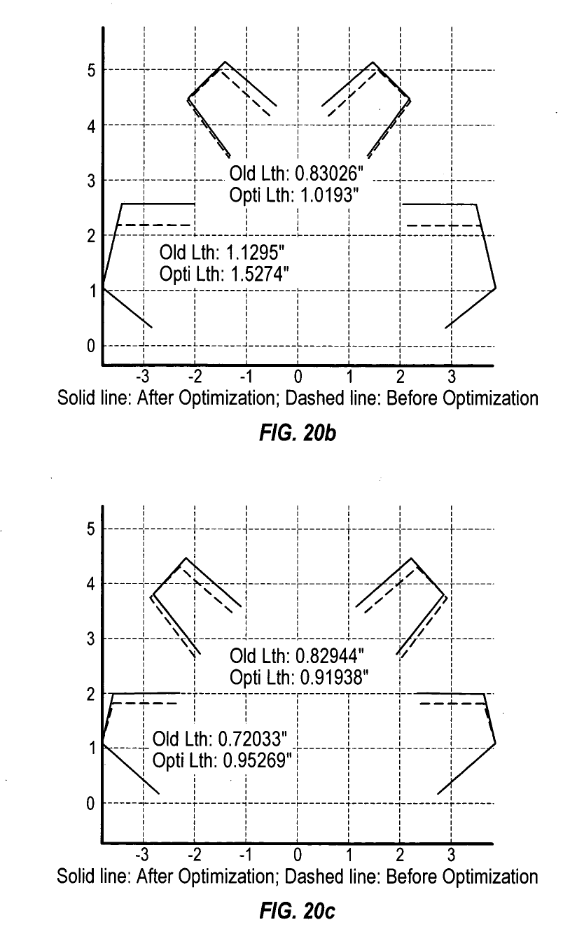

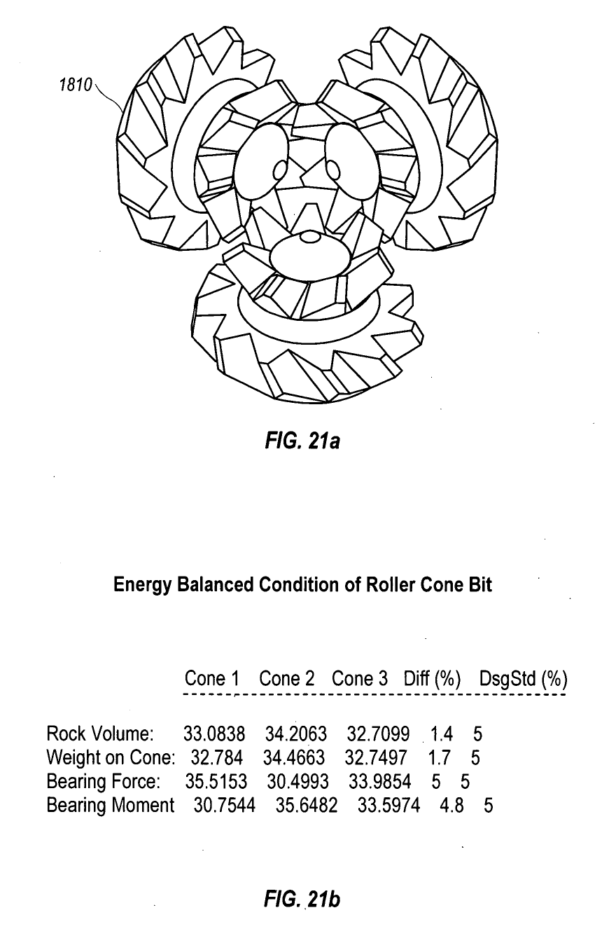

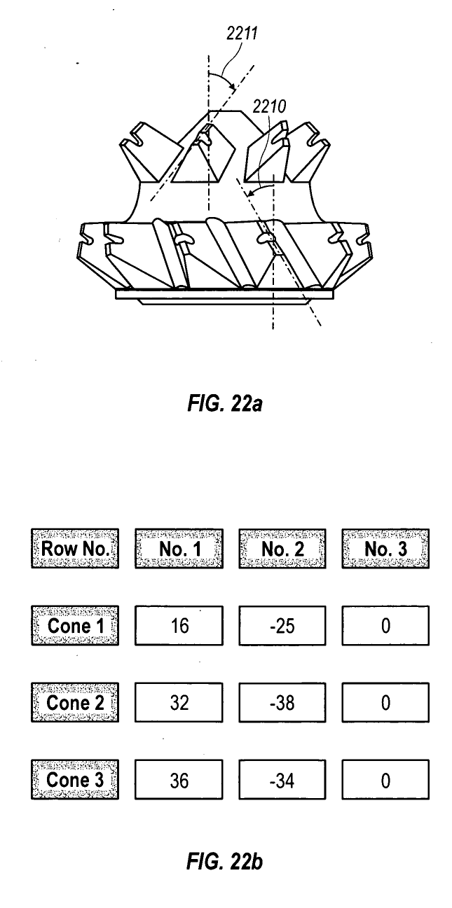

A 12¼″ steel tooth bit (IADC 117) 1810 shown in FIG. 18a is used as an example. As shown in FIG. 18b, the conventional bit was unbalanced. The difference of rock removed by each cone was about 7.2%. The difference between bearing axial force is as high as 11.1%. Bit 1810 is redesigned and shown in FIGS. 21a. The balanced condition is shown in FIGS. 21b. It is seen that three cones now remove almost the same amount of rock volume and are subject to almost the same loads. The bearing force and the cone moment are not so well balanced, but the differences are less than 5%. Field run experience of the bit shows that this difference is acceptable. FIGS. 20a-c show the crest length of teeth and tooth locations on all three cones before and after optimization. FIGS. 22a illustrates the definition of a positive tooth orientation angle 2210 and a negative tooth orientation angle 2211. FIGS. 22b lists the orientation angles used for the three cones in energy-balanced bit 1810.

According to a disclosed class of innovative embodiments, there is provided: A method of designing roller-cone drill bits, comprising the actions of: a) simulating operation of a drill bit having multiple design parameters; b) adjusting said multiple bit design parameters by reference to a multi-objective optimization which combines objectives related to maximizing rock removal of subelements, objectives related to equalization of rock removal among groups of said subelements, and also objectives related to minimization of one or more shock loading components; and c) after one or more iterations of said steps a) and b), outputting the results of said step b).

According to another disclosed class of innovative embodiments, there is provided: A method of designing roller-cone drill bits, comprising the actions of: adjusting multiple bit design parameters by reference to a multi-objective optimization which combines objectives related to maximizing rock removal of subelements, objectives related to equalization of rock removal among groups of said subelements, and also objectives related to minimization of one or more shock loading components.

According to another disclosed class of innovative embodiments, there is provided: A method of designing roller-cone drill bits, comprising the actions of: a) simulating operation of a drill bit having multiple design parameters; b) adjusting multiple bit design parameters by reference to a multi-objective optimization which combines objectives related to maximizing rock removal of subelements, objectives related to equalization of rock removal among groups of said subelements, and also anti-tracking objectives; and c) after one or more iterations of said steps a) and b), outputting the results of said step b).

According to another disclosed class of innovative embodiments, there is provided: A method of designing roller-cone drill bits, comprising the actions of: adjusting multiple bit design parameters by reference to a multi-objective optimization which combines objectives related to maximizing rock removal of subelements, objectives related to equalization of rock removal among groups of said subelements, and also anti-tracking objectives.

According to another disclosed class of innovative embodiments, there is provided: An algorithm for optimizing a roller-cone bit, comprising the actions of: reading the initial information on the bit to be optimized, the formation to be drilled, and the operational parameters; defining the optimization objectives based on the bit size and type; simulating the operation of the drill bit having the operational design parameters through the formation to be drilled; outputting the forces on the teeth, cones, and bit; bit-balanced conditions; and bottom hole pattern; defining design variables and their bounds; generating linear and nonlinear constraints on the design variables; calling a simplified two-dimensional bit/formation interaction model; scaling said two-dimensional results using the initial three-dimensional results; determining optimized bit parameters using said scaled results; and redesigning said bit using the optimized bit parameters.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the various teachings can optionally be adapted to two-cone or four-cone bits.

In one contemplated class of alternative embodiments, the orientations of teeth can be perturbed about the optimal value, to induce variation between the gage rows of different cones (or within an inner row of a single cone), to provide some additional resistance to tracking.

Of course, the bit will also normally contain many other features besides those emphasized here, such as gage buttons, wear pads, lubrication reservoirs, etc.

Additional general background, which helps to show the knowledge of those skilled in the art regarding implementations and the predictability of variations, may be found in the following publications, all of which are hereby incorporated by reference: APPLIED DRILLING ENGINEERING, Adam T. Bourgoyne Jr. et al., Society of Petroleum Engineers Textbook series (1991), OIL AND GAS FIELD DEVELOPMENT TECHNIQUES: DRILLING, J.-P. Nguyen (translation 1996, from French original 1993), MAKING HOLE (1983) and DRILLING MUD (1984), both part of the Rotary Drilling Series, edited by Charles Kirkley, VECTOR OPTIMIZATION FOR CONTROL WITH PERFORMANCE AND PARAMETER SENSITIVITY INDICES, F. W. Gembicki, Ph.D thesis, Case Western Reserve Uni., Cleveland, Ohio, (1974), and COMPUTER-AIDED CONTROL SYSTEM DESIGN USING OPTIMIZATION TECHNIQUES, A. C. W. Grace, Ph.D thesis, University of Wales, UK (1989).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A method of designing roller-cone drill bits, comprising the actions of:
a) simulating operation of a drill bit having multiple design parameters through the formation to be drilled;
b) adjusting said multiple bit design parameters by reference to a multi-objective optimization which combines
objectives related to maximizing rock removal of subelements,
objectives related to equalization of rock removal among groups of said subelements, and also
objectives related to minimization of one or more shock loading components; and
c) after one or more iterations of said steps a) and b), outputting the results of said step b).

2. The method of claim 1, wherein said objectives related to maximizing rock removal consist of rate of penetration.

3. The method of claim 1, wherein said objectives related to minimization of one or more shock loading components consist of balancing the average the bit-axial force components.

4. The method of claim 1, wherein said objectives related to minimization of one or more shock loading components consist of minimizing the bit net lateral force due to tooth interactions with the bottom of the formation to be drilled.

5. The method of claim 1, wherein said objectives related to minimization of one or more shock loading components consist of minimizing the distance between teeth surfaces.

6. The method of claim 1, wherein said objectives related to minimization of one or more shock loading components consist of equalizing the width of the uncut formation rings.

7. A roller cone bit designed by the method of claim 1.

8. A method of drilling using bits designed by the method of claim 1.

9. A method of designing roller-cone drill bits, comprising the actions of:
adjusting multiple bit design parameters by reference to a multi-objective optimization which combines
objectives related to maximizing rock removal of subelements,
objectives related to equalization of rock removal among groups of said subelements, and also
objectives related to minimization of one or more shock loading components.

10. The method of claim 9, wherein said objectives related to maximizing rock removal consist of rate of penetration.

11. The method of claim 9, wherein said objectives related to minimization of one or more shock loading components consist of balancing the average the bit-axial force components.

12. The method of claim 9, wherein said objectives related to minimization of one or more shock loading components consist of minimizing the bit net lateral force due to tooth interactions with the bottom of the formation to be drilled.

13. The method of claim 9, wherein said objectives related to minimization of one or more shock loading components consist of minimizing the distance between teeth surfaces.

14. The method of claim 9, wherein said objectives related to minimization of one or more shock loading components consist of equalizing the width of the uncut formation rings.

15. A roller cone bit designed by the method of claim 9.

16. A method of drilling using bits designed by the method of claim 9.

17. A method of designing roller-cone drill bits, comprising the actions of:
a) simulating operation of a drill bit having multiple design parameters through the formation to be drilled;
b) adjusting multiple bit design parameters by reference to a multi-objective optimization which combines
objectives related to maximizing rock removal of subelements,
objectives related to equalization of rock removal among groups of said subelements, and also
anti-tracking objectives; and
c) after one or more iterations of said steps a) and b), outputting the results of said step b).

18. The method of claim 17, wherein said objectives related to maximizing rock removal consist of rate of penetration.

19. The method of claim 17, wherein said objectives related to anti-tracking consist of minimizing the width of the uncut formation rings.

20. The method of claim 17, wherein said objectives related equalization of rock removal among groups of said subelements consist of balancing the average the bit-axial force components.

21. The method of claim 17, wherein said objectives related to equalization of rock removal among groups of said subelements consist of minimizing the bit net lateral force due to tooth interactions with the bottom of the formation to be drilled.

22. The method of claim 17, wherein said objectives related to equalization of rock removal among groups of said subelements consist of equalizing the width of the uncut formation rings.

23. A roller cone bit designed by the method of claim 17.

24. A method of drilling using bits designed by the method of claim 17.

25. A method of designing roller-cone drill bits, comprising the actions of:
adjusting multiple bit design parameters by reference to a multi-objective optimization which combines
objectives related to maximizing rock removal of subelements,
objectives related to equalization of rock removal among groups of said subelements, and also
anti-tracking objectives.

26. The method of claim 25, wherein said objectives related to maximizing rock removal consist of rate of penetration.

27. The method of claim 25, wherein said objectives related to anti-tracking consist of minimizing the width of the uncut formation rings.

28. The method of claim 25, wherein said objectives related equalization of rock removal among groups of said subelements consist of balancing the average the bit-axial force components.

29. The method of claim 25, wherein said objectives related to equalization of rock removal among groups of said subelements consist of minimizing the bit net lateral force due to tooth interactions with the bottom of the formation to be drilled.

30. The method of claim 25, wherein said objectives related to equalization of rock removal among groups of said subelements consist of equalizing the width of the uncut formation rings.

31. A roller cone bit designed by the method of claim 25.

32. A method of drilling using bits designed by the method of claim 25.

33. An algorithm for optimizing a roller-cone bit, comprising the actions of:
reading the initial information on
the bit to be optimized,
the formation to be drilled, and
the operational parameters;
defining the optimization objectives based on the bit size and type;
simulating the operation of the drill bit having the operational design parameters through the formation to be drilled;
outputting
the forces on the teeth, cones, and bit;
bit-balanced conditions; and
bottom hole pattern;
defining design variables and their bounds;
generating linear and nonlinear constraints on the design variables;
calling a simplified two-dimensional bit/formation interaction model;
scaling said two-dimensional results using the initial three-dimensional results;
determining optimized bit parameters using said scaled results; and
redesigning said bit using the optimized bit parameters.

34. The algorithm of claim 33, wherein said linear constraints include the upper and lower bounds of a tooth crest length.

35. The algorithm of claim 33, wherein said linear constraints include the upper and lower bounds of an orientation angle.

36. The algorithm of claim 33, wherein said nonlinear constraints include the clearance between teeth surfaces on all cones.

37. The algorithm of claim 33, wherein said nonlinear constraints include the width of the uncut formation rings on the bottom of the formation to be drilled.

38. A roller cone bit designed by the algorithm of claim 33.

39. A method of drilling using bits designed by the algorithm of claim 33.
